(19) United States
(12) Patent Application Publication
(10) Pub. No.: US 2025/0163286 A1
(43) Pub. Date: May 22, 2025

(54) SUSTAINABLE RADIATION CURABLE HYBRID OFFSET INKS

(71) Applicant: SUN CHEMICAL B.V., LV Weesp (NL)

(72) Inventors: Freddy DELAHAYE, Thourotte (FR); Annabelle PETIT, Thourotte (FR); Saeid SAVARMAND, Carlstadt, NJ (US); Christian JOHNKE, Karlstein am Main (DE); Jean-Hugues BLAIZEAU, Thourotte (FR)

(73) Assignee: SUN CHEMICAL B.V., LV Weesp (NL)

(21) Appl. No.: 18/833,291

(22) PCT Filed: Feb. 9, 2023
(86) PCT No.: PCT/EP2023/053227

§ 371 Date: Jul. 25, 2024

Related U.S. Application Data
(60) Provisional application No. 63/308,106, filed on Feb. 9, 2022.

(51) Int. Cl. C09D 11/102; C09D 7/63; C09D 11/101

(52) U.S. Cl. CPC C09D 11/102; C09D 7/63; C09D 11/101

(57) ABSTRACT

The present invention provides radiation-curable hybrid ink and coating compositions with high bio renewable content, comprising large amounts of inert hard resin. The radiation hybrid ink and coating compositions have good lithographic properties, low roller swelling, and a low gloss-back effect when overprinted with a UV varnish. The ink and coating compositions are useful for lithographic wet printing.

### CROSS REFERENCE TO RELATED APPLICATIONS

The present application is a § 371 National Phase application based on PCT/EP2023/053227 filed Feb. 9, 2023, which claims the benefit of U.S. Provisional Application No. 63/308,106, filed Feb. 9, 2022, the subject matter of each of which is incorporated by reference in their entirety.

### FIELD OF THE INVENTION

The present invention relates to high Bio Renewable Content (BRC) radiation curable hybrid inks and coatings comprising energy-curable monomers, oligomers and photo initiators, as well as raw materials used in conventional offset inks, such as oils, alkyd resins, and hard resins. The radiation-curable hybrid inks and coatings are suitable for application by lithographic printing.

### BACKGROUND

Conventional inks for lithographic printing are formulated with vegetable or mineral oils, alkyd resins, and phenolic or hydrocarbon resins. The oils penetrate into the substrate to induce physical drying or setting (“quick-set” effect). However, the quick-set effect cannot be employed when printing on non-porous substrates, such as plastic films. For printing on non-porous substrates, inks are formulated using vegetable oils and their esters (known as drying oils) to dissolve the hard resin and for reducing viscosity. The oils in lithographic inks participate in the drying of the inks by an oxidation reaction.

A major disadvantage of conventional lithographic inks is the slow drying speed. Conventional lithographic inks based on oils and alkyds dry slowly by penetration of the substrate (setting) and oxidation. This negatively impacts the productivity a converter can achieve. Thus, a need exists for producing faster drying inks to improve productivity.

Energy-curable inks have also been employed in lithographic printing. Energy-curable inks have improved gloss and resistance properties. However, there are drawbacks to using energy-curable inks for lithographic printing. For example, pigment wetting of energy-curable inks is not as good as for conventional inks, resulting in print density problems. In addition, energy-curable inks show problems with low shear viscosity, less stable emulsion with water, and higher tack. The lack of stability in an emulsion with water results in a smaller water balance on the printing press. Higher tack may lead to picking of fibers or coating when printing on paper or board. Moreover, classification of raw materials used in energy-curable inks is much more critical for health than in conventional system. The materials used for radical polymerization are mainly derived from synthetic processes using petrochemically derived materials. Bio-sourced material usage is limited in inks of the art, which provides energy-curing inks with low BRC values.

In general, inks, either conventional or UV drying, contain waxes to enable good printing and conversion processes, by avoiding scratches and print deterioration. Theses waxes are usually synthetic, based on micronized polyethylene (PE) and polytetra fluoroethylene (PTFE). The European Chemicals Agency (ECHA) proposed the regulatory definition of a microplastic as a “material consisting of solid polymer-containing particles, to which additives or other substances may have been added, and where ≥1% weight by weight (w/w) of particles have (i) all dimensions 1 nm≤x≤5 mm, or (ii), for fibers, a length of 3 nm≤x≤15 mm and length to diameter ratio of >3. Polymers that occur in nature that have not been chemically-modified (other than by hydrolysis) are excluded, as are polymers that are (bio) degradable”. Regulation on microplastics does not directly affect ink formulations because particles are dispersed into the network of polymerized binders and are not free. However, in terms of sustainable development, high BRC inks should not contain any synthetic waxes, such as PE or PTFE wax.

Depending on the requirements of a particular print job, a converter may want to use both conventional and energy-curable lithographic inks. Conventional inks are generally printed with N-buna-nitrile rubber (NBR) rollers, while energy-curable inks are generally printed with ethylene-propylene-diene-monomer (EPDM) rollers. Energy-curable inks are not compatible with NBR rollers, and conventional inks are not compatible with EPDM rollers. Use of an incompatible ink leads to roller swelling, thus compromising print-quality. To employ both conventional and energy-curable inks on the same press, a converter must switch rubber rollers and blankets on the printing press, to a hybrid system.

Often, to improve gloss of prints made with conventional inks, a converter will apply an energy-curable topcoat over the printed substrate. However, the energy-curable topcoat is typically not compatible with oil and alkyd-based inks, resulting in “gloss back”. Gloss back is the phenomenon where a radiation-curable coating applied over a conventional ink loses gloss within a short period after cure, typically within a day. To improve gloss back, it is generally necessary to apply a water-based primer between the print and the energy-curable topcoat.

In an attempt to overcome these problems, there has been an effort to develop “hybrid” inks which comprise both conventional ink components and energy-curable components. Hybrid inks are described by Paul Gaevert at Radtech Conference Nov. 3-5, 2003, Conference Proceedings “Ink performance properties of UV, conventional and hybrid sheet-fed inks” Tony Bean in “Radtech Report October 2009, “Hybrid Sheetfed lithographic systems—State of the Art;” and Dieter Kleeberg in “Quality enhancement with hybrid production” in Process 2006 (publication of press maker KBA).

Radiation-curable hybrid inks are radiation-curable inks which also contain raw materials from conventional inks, such as oils, alkyd resins, and hard resins. Hybrid inks combine different drying properties and preferably dry under UV (ultraviolet) or EB (electron beam) radiation, and also by oxidation with air or heat drying. Moreover, the inks can dry by penetration of the oils into the substrate, like oil-based conventional inks. One advantage that may be observed with hybrid inks is that they can be directly overprinted with a radiation-curable coating with only minor loss in gloss (i.e. minor gloss back). Consequently, an aqueous primer between the ink and coating, as well as a double coater on press, can be spared.

However, because radiation-curable hybrid inks are based on chemically different materials, such as non-polar vegetable oils or minerals, and phenolic or hydrocarbon resins, in combination with the more polar monomeric acrylates and resins, good compatibility is not easy to achieve.

One drawback of hybrid inks is that the stability of the hybrid ink has to be balanced. In the presence of oxygen, the oil-based materials can start to increase viscosity due to oxidation, especially in the presence of a dryer, whereas, on the other hand, oxygen stabilizes radiation-curable components such as acrylates.

A major disadvantage of the currently available hybrid inks is that due to the incorporation of oils and alkyds, which dry slowly by penetration (setting) and oxidation, these inks have slower drying speeds. As the determining factor for the ink drying of these inks is the setting of the oil and oxidation of the alkyd, a converter does not achieve the productivity (line speed) associated with a 100% radiation-curable ink. This is especially critical for non-porous substrates, into which oils do not penetrate.

As a result, typical hybrid inks as described in the literature contain a large amount of radiation-curable materials, but only a smaller amount of oils and alkyds. The formulation of a typical radiation-curable hybrid ink is given in the proceedings of Radtech conference (Paul Geavert, Radtech Europe 2003), where the materials of conventional inks (oils and alkyds) are limited to 15%. In general, typical radiation-curable hybrid inks of the art comprise 5-15% vegetable oils and alkyd resins, 0-15% polyester acrylates, 0-10% epoxy acrylates, 0-50% vegetable oil acrylates, 5-15% acrylic monomers, 14-24% pigments, 4-8% fillers, 4-8% photoinitiators, and less than 1% stabilizers and inhibitors. This is also confirmed in a review article (“Hybrid Sheetfed lithographic systems-State of the Art”, Tony Bean, Radtech report 2009), wherein typical hybrid inks contain only a small amount of conventional raw materials.

The above-mentioned formulation ranges show slow curing speed (low reactivity), as well as low solvent-resistance, due to the non-reactive inert oils and alkyds present However, due to the limited amount of conventional materials, these inks exhibit very similar lithography compared to a typical UV-ink. The lithographic performance of typical UV-inks is inferior to conventional inks using non-reactive inert oils and alkyds.

Thus, the only advantage of the above-mentioned formulation ranges is that such typical radiation-curable hybrid inks can be run both on rollers for radiation-curable inks as well as those for conventional inks. However, the target of getting a substantially better lithography is not achieved.

Moreover, many hybrid inks of the art comprise compounds that are classified as carcinogenic, mutagenic or reprotoxic (CMR) under the EU Classification, Labelling and Packaging of substances (CLP) Regulation 1272/2008. As these compounds are hazardous to human health it is desirable to identify new hybrid ink and coating compositions that do not comprise CMR compounds and that have comparable properties, such as gloss back, tack, viscosity, and curing, to compositions of the art.

It can therefore be seen that the demands required from the formulation of high BRC, low CMR compound-containing, hybrid inks and coatings is enormously complex and optimizing the properties of these inks and coatings is equally complex. From a lithographic standpoint, it is advantageous to have an ink comprising a high amount of oils, alkyds, and hard resins. Conversely, in view of drying speed, productivity and gloss back, a high amount of radiation-curable monomers and oligomers is favorable.

### SUMMARY OF THE INVENTION

The present invention offers a complex mix of conventional and energy-curing raw materials with high BRC content. The inks and coatings of the invention do not comprise synthetic waxes and have good stability over time. The inks show good lithographic properties and can be overprinted with a UV varnish with only minor gloss back and have good inter-coat adhesion. The inventive hybrid inks and coatings exhibit good lithographic properties relative to 100% radiation-curable inks, due to better pigment wetting of the alkyds and conventional resins, relative to (meth)acrylate monomers and oligomers. The inventive sustainable hybrid inks and coatings of the invention may be free of carcinogenic, mutagenic, or reprotoxic (CMR) materials.

The present invention provides a high BRC lithographic radiation hybrid ink or coating providing a minimum Percent of Modern Carbon (PMC) of at least 40% and preferably at least 45% according to ASTM D6866 (method B).

The present invention provides a high BRC lithographic radiation hybrid ink or coating composition comprising:
a) 10 wt % to 30 wt % one or more inert hard resins selected from the group consisting of rosin resins, rosin resin derivatives, hydrocarbon resins, modified hydrocarbon resins, iso diallyl phthalate resins, non-phthalate allyl resins, and combinations thereof;
b) 10 to 60% non-UV raw material selected from the group consisting of inert hard resins, vegetable oils, vegetable oil esters, alkyds resins, antioxidants, and combinations thereof; and
c) 5 wt % to 45 wt % one or more multifunctional (meth)acrylate monomers and/or oligomers; and
   wherein, the ink or coating comprises ≥40% BRC, more preferably ≥45% BRC.

The lithographic radiation hybrid ink or coating composition preferably comprises less than 10 wt % of CMR compounds, and more preferably less than 5 wt % CMR compounds, and even more preferably is substantially free of CMR compounds.

The present invention also provides more sustainable composition using biosourced waxes instead of synthetic waxes. The present invention also provides a method of printing an article comprising applying the lithographic radiation-curable hybrid ink of the invention as a UV-coldset lithographic ink, or as a UV-heatset lithographic ink.

The present invention further provides a printed article comprising the energy-curable hybrid lithographic ink of the invention. The present invention also provides conventional concentrated pigment bases and energy-curing technology varnish (TV) to simplify spot colour preparation, to just mixing the required coloured bases with the TV in the appropriate ratio.

### DETAILED DESCRIPTION OF THE INVENTION

It is to be understood that the foregoing general description and the following detailed description are exemplary and explanatory only, and are not restrictive of any subject matter claimed.

Unless otherwise defined, all technical and scientific terms used herein have the same meaning as is commonly understood by one of skill in the art to which the inventions belong. All patents, patent applications, published applications and publications, websites and other published materials referred to throughout the entire disclosure herein, unless noted otherwise, are incorporated by reference in their entirety for any purpose.

The present invention provides radiation-curable hybrid inks and coatings, having good lithographic properties and a low gloss-back effect when overprinted with a UV-varnish. The inks are useful for lithographic wet printing.

### Definitions

In this application, the use of the singular includes the plural unless specifically stated otherwise. As used herein, the singular forms “a,” “an” and “the” are intended to include the plural forms as well, unless the context clearly indicates otherwise.
In this application, the use of “or” means “and/or” unless stated otherwise.
As used herein, the terms “comprises” and/or “comprising” specify the presence of the stated features, integers, steps, operations, elements, and/or components, but do not preclude the presence or addition of one or more other features, integers, steps, operations, elements, components, and/or groups thereof. Furthermore, to the extent that the terms “includes,” “having,” “has,” “with,” “composed,” “comprised” or variants thereof are used in either the detailed description or the claims, such terms are intended to be inclusive in a manner similar to the term “comprising.”
As used herein, the term “(meth)acrylate” refers to both acrylate and methacrylate compounds. When the term “acrylate” is used alone, it is understood that it encompasses both acrylate and methacrylate compounds.
As used herein, an “energy-curable” or “radiation-curable” ink or coating composition is a composition that can be cured by any suitable source of actinic radiation. Suitable sources of UV radiation include, but are not limited to, a high-voltage mercury bulb, a medium-voltage mercury bulb, a xenon bulb, a carbon arc lamp, a metal halide bulb, iron-doped lamps, a UV-LED lamp or sunlight. Other sources of radiation include, but are not limited to, microwave, infrared, electron beam, visible light, x-ray, laser, and the like.
As used herein, a “radiation-curable hybrid ink” or “energy-curable hybrid ink” is an ink or coating composition which contains energy-curable components (for example, but not limited to, acrylate monomers), and also contains raw materials from conventional inks, such as, but not limited to, oils, alkyd resins, and hard resins.
As used herein, the term “article” or “articles” means a substrate or product of manufacture. Examples of articles include, but are not limited to: substrates such as paper, plastic, plastic or polymer film, glass, ceramic, metal, composites, and the like; and products of manufacture such as publications (e.g. brochures), labels, and packaging materials (e.g. cardboard sheet or corrugated board), containers (e.g. bottles, cans), a polyolefin (e.g. polyethylene or polypropylene), a polyester (e.g. polyethylene terephthalate), a metalized foil (e.g. laminated aluminum foil), metalized polyester, a metal container, and the like.
As used herein, the terms “ink,” “inks,” “coating,” “coatings,” “ink and coating,” and “inks and coatings” are used interchangeably.
As used herein, the terms “inert resin” and “inert hard resin” are used interchangeably.
The term “monomer” refers to a compound that is capable of being polymerized and does not comprise multiple monomeric units.
The term “oligomer” refers to a compound comprising multiple monomeric units. As used herein, the term “oligomer” refers to such a compound with a number average molecular weight of at least 400 Da.
The term “non-UV” refers to compounds that are inert and do not react under photoinitiation conditions, e.g., UV light in the presence of a photoinitiator. The term excludes monomers and oligomers that can be initiated under said conditions, e.g., (meth)acrylates.
Throughout this disclosure, all parts and percentages are by weight (wt % or mass % based on the total weight of the composition, including any solvents) and all temperatures are in ° C. unless otherwise indicated.
Unless otherwise indicated, all method steps are to be performed in the order in which they are recited.
Compatibility: as used herein, compatibility of components means that the components are miscible at room temperature (23° C.) and do not undergo phase separation for at least one week after mixing.
As used herein, solubility and compatibility are used interchangeably.
Lithographic: a composition suitable for use in lithographic printing.

### Radiation-Curable Hybrid Inks and Coatings

The present application provides energy-curable hybrid inks and coatings suitable for lithographic printing. The inks and coatings of the invention are balanced radiation-curable hybrid inks and coatings containing a mixture of conventional oils and alkyds and inert hard resin.

The present invention provides a lithographic radiation-curable hybrid ink or coating composition comprising:
a) 10 wt % to 30 wt % one or more inert hard resins selected from the group consisting of rosin resins, rosin resin derivatives, hydrocarbon resins, modified hydrocarbon resins, iso diallyl phthalate resins, non-phthalate allyl resins, and combinations thereof; and
b) 10 to 60% non-UV raw material selected from the group consisting of inert hard resins, vegetable oils, vegetable oil esters, alkyd resins, antioxidants, and combinations thereof; and
c) 5 wt % to 45 wt % one or more multifunctional acrylate monomers and/or oligomers
d) 0-10% monofunctional (meth)acrylate monomers and/or oligomers;
   and wherein the ink or coating composition comprises ≥40% biorenewable content.

### Advantages of the Present Invention

The resultant inks and coatings show good lithographic properties and can be overprinted with a UV varnish, with only minor gloss back, and good intercoat adhesion. The inventive hybrid inks exhibit good lithographic properties vs 100% radiation-curable inks due to better pigment wetting of alkyds and conventional resins vs acrylate monomers and oligomers. The inventive hybrid inks also provide faster drying and curing, increasing productivity, due to the inclusion of energy-curable monomers. The higher amount of conventional, acrylate compatible inert hard resins vs. oil and alkyds helps to reduce cure retardation and increase compatibility with acrylates.

The inventors have now unexpectedly observed that with the introduction of high amounts of inert hard resin, such as phenolic rosin resin, maleic rosin resin, and/or an aromatic hydrocarbon resin, the total amount of conventional ink ingredients in a hybrid ink can be considerably increased, which favors lithography, while minimally affecting the drying speed.

It is referred to make a conventional varnish with high amounts of inert hard resin, such as maleic rosin, aromatic hydrocarbon resin, and/or phenolic rosin resin, in vegetable oils, which can be one or more drying oils, semi-drying oils and non-drying oils. A compatibility ratio must be determined between the conventional materials and the (meth)acrylated monomers and oligomers.

Though not bound by any specific theory, the inventors believe that the inert hard resin, even when present in large amounts, becomes immediately hard and solid once the radiation-curable acrylate matrix is dried, so that the drying properties (line speed) is less affected. The inks and coatings of the invention can be run at conventional printing speeds used in the art, such as at least 10,500 sheets/hour.

Moreover, a second matter to improve radiation cure is to partly replace or limit the often proposed vegetable oil acrylates, which are known for sluggish radiation cure, by a very reactive multifunctional acrylates, such as trifunctional acrylates including propoxylated glycerol triacrylate.

In contrast to the common belief that, for compatibility reasons, an oil-modified acrylate has to be used in hybrid inks as it is compatible with conventional oils and alkyds, the inventors found that many common multifunctional acrylates such as propoxylated glycerol triacrylate can be used to a large extent. However, it is more difficult to include highly ethoxylated acrylic monomers in large amounts, which can cause some incompatibility due to their polarity. While it is possible to use monofunctional acrylate(s) in the hybrid inks of the present invention, it is preferred that these materials be used at a maximum of 10%, more preferably a maximum of 5%.

Unlike many commercial hybrid inks and coatings, which are in fact more like a typical UV ink and contain only some conventional materials (e.g. Suncure Hybrite, Sun Chemical), the ink of the present invention contain a considerable amount of conventional ink raw materials to get a good lithographic performance. The amounts of the materials are balanced in a way that a good part of the oils and alkyd resins are exchanged for an acrylate soluble inert hard resin, such as for example a modified maleic rosin or modified phenolic rosin or hydrocarbon resin, so that the drying speed is less affected.

An advantage of the hybrid ink of the present invention is that the lithography is positively affected and shows less misting, less feedback and a wider water-window than typical 100% radiation-curable inks.

Another advantage, due to the oil-based components, is that the color strength and flow from the ink duct is often better than with 100% radiation-curable inks, as the oil-based materials such as alkyd resin evenly disperse and encapsulate pigments and lead to good color strength and good flow.

Because of intermediate behavior between conventional and UV, this ink can be run on press on conventional rollers but preferably on combi rollers using hybrid blanket or UV blanket. The ink of the present invention can preferably be washed with both conventional & UV press wash solutions, which was confirmed during the lab study and press trials on Heidelberg MO & Roland 700 presses.

### Properties of the Hybrid Inks and Coatings of the Invention

### Viscosity

Typically, radiation-curable hybrid inks and coatings of the present invention show a viscosity of 5-100 Pa·s at a shear rate of D=50 l/s at 23° C. Preferred is a viscosity of 20-60 Pa·s. The flow of the radiation-curable hybrid inks of the invention is also measured. Typical values for flow, as measured using the inclined plane test (e.g. an inclined aluminum plate) at an incline of 90° and with 1 ml of ink are 2-15 cm after 15 minutes.

### Tack

The inks of the present invention show a tack of 12-40 units measured using an “Inkometer” from Thwing Albert company. The more preferred tack is <30 units. Tack affects print quality. If tack is too high, there may be damage to a substrate such as paper, known as “picking,” where fibers of the paper substrate are pulled onto the ink blanket. Tack that is too low can lead to problems such as inadequate ink feed, transfer and distribution.

### Lithographic Performance

The present hybrid ink has been run on Roland 700 press (combi rollers from Böttcher and hybrid blanket from Trelleborg; 4% Sunfount 480 and 3% IPA fount) at 12500 sheets/h on Invercote G substrate at 1.45 OD target. Lithographic behavior is similar to standard offset sheetfed ink with acceptable ink/water balance.

### Gloss Back

In order to exploit the highest productivity of a fast curing UV-ink, an in-line coating with a UV overprint coating, which also provides high gloss, is often preferred. However, when a conventional sheet-fed ink is overprinted with a UV-ink and end-cured, the initial gloss of the coating after cure often drops within 24 hours by 10-25 gloss points. This also depends on the kind of substrates and is especially critical on open porous, non-coated substrates. This is often counter-acted by applying an aqueous primer between conventional ink and UV over-print varnish. However, this requires a double coater with an integrated thermal or infrared dryer on press and an additional aqueous coating, which adds additional time and expense to the process. Although these drying systems are available for presses such as ManRoland 700 Ultima or Heidelberg Speedmaster Duo, they are more a niche technology. By using a radiation-curable hybrid ink of the present invention instead of a conventional ink, this can often be avoided and the gloss back effect is low without the need for an aqueous primer. With the hybrid inks of the present invention a balance was found with which a low gloss back effect is achieved giving a stable gloss, which is usually difficult to achieve with an aqueous coating. Nonetheless, the inks show a good lithographic performance. A small amount of gloss back may be seen when using the hybrid inks of the present invention, but preferably the degree of gloss back would be within preferred ranges. For high gloss hybrid inks (for example those with an initial gloss of >60), a drop in gloss <10 units is preferred; more preferably <7 units.

### Replacement of Carcinogenic, Mutagenic, and Reprotoxic (CMR) Compounds

Hybrid inks of the art may comprise compounds classified as the carcinogenic, mutagenic, or reprotoxic (CMR) under the EU Classification, Labelling and Packaging of substances (CLP) Regulation 1272/2008. Although the use of such compounds may provide hybrid inks and coatings with advantageous properties, these compounds are hazardous to health and their use should therefore be avoided. CMR compounds that are present in hybrid inks of the art include trimethylolpropane triacrylate (TMPTA), silicone diacrylates, such as Ebecryl 350, 2-dimethylamino-2-(4-methyl-benzyl)-1-(4-morpholin-4-yl-phenyl)-butan-1-one (ominirad 379), and multifunctional aminobenzoate derivatives such as 1,3-propanediol, 2-ethyl-2-(hydroxymethyl), polymer with oxirane, 4-(dimethylamino)benzoate (Genopol AB-2).

The inventors have discovered hybrid inks that do not comprise any CMR compounds and that have consistent properties with hybrid inks of the art. The ink or coating composition of the invention may comprise less than 20 wt % of compounds classified as carcinogenic, mutagenic, or reprotoxic (CMR), and preferably less than 10 wt % of CMR compounds, or even more preferably less than 5 wt % or CMR compounds. The ink or coating composition of the invention is most preferably substantially free of CMR compounds.

The inventors were surprised to find that replacing CMR compounds, including the multifunctional acrylate TMPTA described as essential components of the hybrid inks of the art, can be replaced by alternative non-CMR compounds. Moreover, the inventors found that the resulting hybrid inks have at least comparable properties to compositions of the art comprising CMR compounds.

In particular, the inventors discovered that (meth)acrylates classified as CMR compounds could be replaced in compositions of the art by one or more (meth)acrylate oligomers selected from the group consisting of acrylated oils, epoxy acrylates, oil modified polyester acrylates, acrylated polyurethanes, acrylated polyacrylates, acrylated polyethers, acrylated amines, and combinations thereof, to provide hybrid inks and coating having comparable properties. In particular, at least comparable tack, viscosity, and cure, relative to the inks of the art comprising CMR compounds. Cure is assessed using the UV set-off test described in the examples.

More preferred is replacing the CMR compounds with one or more (meth)acrylate oligomers selected from the group consisting of polyester acrylates, acrylated polyurethanes, acrylated polyethers, and combinations thereof.

### Biorenewable Content

The hybrid ink or coating compositions of the invention have a biorenewable content of at least 40%, and preferably at least 45 wt %. The inventors were surprised to find that replacing components of inks of the art with alternatives having a high BRC provided hybrid inks having at least comparable properties to compositions of the art not comprising the BRC content of the invention.

As used herein, sustainability refers to the BRC content of the material. Thus, improving the sustainability of packaging relates to increasing the BRC content of the packaging, for example by using a lithographic radiation curable hybrid ink or coating composition of the invention instead of an alternative ink or curing.

Components and their Preferred Amounts

### Hybrid Inks and Coatings

The hybrid inks and coatings of the present invention may comprise vegetable oils, vegetable oil esters, and vegetable alkyd resins in an amount between 0 and 40 wt %, such as 0-25 wt %; inert hard resin in an amount of >10 wt %, preferably in an amount between 10-30 wt %; (meth)acrylate oligomers in an amount between 10-40 wt %; and (meth)acrylate monomers in an amount between 0-10%. The hybrid inks and coatings may comprise less than 20 wt % of compounds classified as CMR. The hybrid inks and coatings optionally further comprise a colorant (pigment or dye) in an amount of between 0-40 wt %; extenders and fillers in an amount of between 0-10 wt %; photoinitiators in an amount of between 0-10 wt %; and additives in an amount of between 0-4 wt %.

The preferred total amount of vegetable oils, vegetable oil and esters, alkyds and inert hard resin is >10%, more preferably >20%, more preferably >30%, more preferably >40%, more preferably >50%. The preferred amount of inert hard resin is >10%, more preferably >13%.

The hybrid inks and coatings of the invention preferably comprise between 12 and 26 wt % of inert hard resin, between 15 and 25 wt % vegetable oils, vegetable oil esters, and vegetable alkyd resins, between 15 and 35 wt % of one or more multifunctional (meth)acrylate oligomers, and less than 5 wt % monofunctional (meth)acrylate monomers and oligomers. The composition preferably has a biorenewable content of ≥45%. The hybrid inks and coatings preferably comprises less than 5 wt % of compounds classified as CMR.

Of the 15 and 25 wt % vegetable oils, vegetable oil esters, and alkyds, in the preferred hybrid inks and coatings of the invention, preferably between 15 and 20 wt % is vegetable oils and vegetable oil esters and between 3 and 10 wt % is vegetable alkyd resins. The precise formulation will also depend on the targeted ink properties.

### Ratio of Inert Resins, Vegetable Oils, Vegetable Oil Esters, and Alkyds to (Meth)Acrylate Monomers and Oligomers.

The inert resins, vegetable oils, vegetable oil esters, and alkyds maybe incorporated into the inks or coatings of the invention in combination with the (meth)acrylate monomers and oligomers to provide a ratio inert resins, vegetable oils, vegetable oil esters, and alkyds to (meth)acrylate monomers and oligomers of between 0.1:1.0 and 2.0:0.0, preferably between 0.5:1.0 and 2.0:1.0, and more preferably between 0.5:1.0 and 1.0:1.0.

### Inert Hard Resins

The radiation-curable hybrid ink and coating compositions of the present invention comprise 10 wt % to 30 wt % one or more inert hard resins, based on the total weight of the ink or coating composition, wherein the inert hard resins are selected from the group consisting of rosin resins, rosin resin derivatives, hydrocarbon resins, modified hydrocarbon resins, iso diallyl phthalate resins, non-phthalate allyl resins, and combinations thereof. The inert hard resins for use in the invention are preferably present in an amount of 10 wt % to 30 wt %; such as 12 wt % to 30 wt %, and more preferably 12 wt % to 25 wt %, and even more preferably 15 wt % to 25 wt %, such as 15 wt % to 20 wt %.

An inert hard resin is typically a natural or synthetic, amorphous material, which, for the purposes of the present invention, preferably forms a tack-free film at room temperature after application to a substrate. Most of these materials are oligomers or polymers.

The inert hard resins for use in the invention are selected from the group consisting of rosin resins, rosin resin derivatives, hydrocarbon resins, modified hydrocarbon resins, iso diallyl phthalate resins, non-phthalate allyl resins, and combinations thereof. Any of these inert hard resins that is compatible and/or soluble with the acrylate monomers and oligomers, vegetable oils, vegetable oil esters, and vegetable alkyd resins, can be used in the hybrid inks of the present invention. Preferred inert hard resins include rosin resin derivatives, such as phenolic rosin resin, as well as iso diallyl phthalate resins and non-phthalate allyl resins such as diallylcycloalkane-based resins.

Rosin resin derivatives consist of a variety of isomers and different chemical structures, such as derivatives of abietic acid, levopimaric acid, neoabietic acid, palustric acid, dehydroabietic acid, pimaric acid and isopimaric acid. The rosin resin derivative for use in the invention may be modified with maleic anhydride (i.e., maleic rosin resin) or fumaric acid and esterified with polyols such as glycerol and pentaerythritol. The rosin resin for use in the invention is preferably a phenolic rosin resin.

The radiation-curable hybrid ink and coating compositions of the present invention may further comprise other resins. For example, the radiation-curable hybrid ink and coating compositions of the invention may comprise one or more resins selected from the group consisting of oil-modified phenolic resins, ketone resins, aldehyde-urea resins, oil modified polyester resins, melamine resins, epoxy resins, polyurethane resins, acrylic styrene resins, and combinations thereof, provided that the resin is soluble/compatible in the acrylic monomers, oligomers, oils and alkyds. When present, these additional resins may be present in an amount of 1 wt % to 20 wt %, based on the total weight of the ink or coating composition. For example, the additional resins are preferably present in an amount of 1 wt % to 15 wt %; such as 5 wt % to 15 wt %; and more preferably in an amount of 10 wt % to 15 wt %.

### (Meth)Acrylate Oligomers

The radiation-curable hybrid ink and coating compositions of the invention further comprise one or more (meth)acrylate oligomers. The one or more (meth)acrylate oligomers are preferably present in an amount of 0.1 wt % to 45 wt %, such as 1 wt % to 30 wt % based on the total weight of the ink or coating composition. The one or more (meth)acrylate oligomers are more preferably present in an amount of from 5 wt % to 40 wt %, such as 10 wt % to 40 wt %, and even more preferably from 15 wt % to 35 wt %, based on the total weight of the ink or coating composition.

The (meth)acrylate oligomers for use in the invention have a number average molecular weight of at least 400 Da, such as preferably between 400 and 3,000 Daltons or between 1000 and 3000 Da. The (meth)acrylate oligomers for use in the invention preferably have an acrylate functionality >2, and more preferably ≥4, and even more preferably ≥6.

Preferably, the (meth)acrylate oligomers have a viscosity of at least 5 Pa·s when measured according to the method described in the examples.

Examples of suitable acrylate oligomers include, but are not limited to, acrylated oils, based on linseed-, soy- and castor oil, epoxy acrylates, urethane acrylates, oil modified polyester acrylates such as Ebecryl 870 (Allnex), acrylated polyurethanes, acrylated polyacrylates, acrylated polyethers and acrylated amines, to impart rheology, pigment wetting, transfer, gloss, chemical resistance and other film properties. Preferred are acrylated oil, polyester acrylates such as oil-modified polyester acrylates, acrylated polyurethanes, acrylated polyethers, and combinations thereof.

The inventors have found that replacing lower molecular weight (meth)acrylates (i.e., components with molecular weights of less than 400 Da) with higher molecular weight oligomeric (meth)acrylates (i.e., components with number average molecular weights of at least 400 (such as between 400 and 3000 Da)) resulted in hybrid inks and coating compositions with improved misting. The (meth)acrylate monomers and (meth)acrylate oligomers of part c) preferably have a molecular weight of at least 400 Da.

### (Meth)Acrylate Monomers

The radiation-curable hybrid ink and coating compositions of the invention may comprise up to 45 wt %, such as 5 wt % to 45 wt %, of one or more multifunctional (meth)acrylate monomers, based on the total weight of the ink or coating composition. The radiation-curable hybrid ink and coating compositions of the invention preferably comprise less than 15 wt % of one or more multifunctional (meth)acrylate monomers.

Examples of the monomers suitable for the inks of the present invention comprise acrylic monomers, having 2-4 acrylic groups. A non-limiting list of examples of acrylate monomers include 1,2-ethylene glycol diacrylate, 1,4-butandiol diacrylate, 1,6-hexandiol diacrylate, dipropylene glycol diacrylate, neopentylglycol diacrylate, ethoxylated neopentylglycol diacrylates, propoxylated neopentylglycol diacrylates, tripropylene glycol diacrylate, bisphenol-A diacrylate, ethoxylated bisphenol-A-diacrylates, bisphenol-A-diglycidylether diacrylate, ethoxylated bisphenol-A-diacrylates, poly(ethylene)glycol diacrylates, trimethylolpropane triacrylate, trimethylolpropane trimethacrylate, ethoxylated trimethylolpropane triacrylates, propoxylated trimethylolpropane triacrylates, propoxylated glycerol triacrylates, pentaerythritol triacrylate, ethoxylated pentaerythritol triacrylates, propoxylated pentaerythritol tetraacrylates, ethoxylated pentaerythritol tetraacrylates, ditrimethylolpropane tetraacrylate, dipentaerythritol pentaacrylate, dipentaerythritol hexaacrylate ethoxylated dipentaerythritol hexaacrylates or mixtures thereof, preferred are ethoxylated trimethylolpropane triacrylates, ethoxylated pentaerythritol triacrylates and propoxylated pentaerythritol tetraacrylates, and combinations thereof.

The radiation-curable hybrid ink and coating compositions of the present invention may further comprise one or more monofunctional (meth)acrylate monomers. When present, the one or more monofunctional acrylate monomers are typically present in an amount of up to 5 wt %, such as 1 wt % to 5 wt %, preferably up to 4 wt %, and more preferably up to 3 wt %, based on the total weight of the ink or coating composition.

(Meth)acrylate monomers for use in the invention include monomers derived from vegetable oils, such as soybean acrylate, and fatty acids. However, the use of such monomers is preferably limited. For example, the inks or coatings of the invention may comprise less than 10 wt % of vegetable oil (meth)acrylates, preferably less than 5 wt % vegetable oil (meth)acrylates, and even more preferably be substantially free of vegetable oil (meth)acrylates.

For example, the one or more monofunctional monomers may be present in an amount of 1 wt % to 3 wt %; or 1 wt % to 2 wt %; or 2 wt % to 5 wt %; or 2 wt % to 3 wt %; or 3 wt % to 5 wt %.

Suitable monofunctional acrylate monomers include, but are not limited to, tertiobutyl cyclohexanol acrylate, 2-(2-ethoxyethoxy)ethyl acrylate, tetrahydrofurfuryl acrylate, lauryl acrylate, 2-phenoxyethyl acrylate, isodecyl acrylate, ethoxylated phenyl acrylate, 3,3,5-trimethyl cyclohexanol acrylate, iso-octyl acrylate, octyl decyl acrylate, polycaprolactone acrylate, ethoxylated nonphenyl acrylate, isobornyl acrylate, cyclic trimethylolpropane formal acrylate, stearyl acrylate, behenyl acrylate, alkoxylated lauryl acrylate, combinations thereof, and the like. Preferred is lauryl acrylate.

### Vegetable Oils and Vegetable Oil Esters

The radiation-curable hybrid ink and coating compositions of the invention may further comprise one or more vegetable oils and vegetable oil esters. When present, the one or more vegetable oils and vegetable oil esters may be present in an amount of 0.1 wt % to 35 wt %, based on the total weight of the ink or coating composition. Preferably, the one or more vegetable oils and vegetable oil esters are present in an amount of 10 wt % to 30 wt %, and even more preferably in an amount of 15 wt % to 25 wt %.

The one or more vegetable oils and vegetable oil esters may preferably be present in an amount of 0.1 wt % to 20 wt %; or 0.1 wt % to 15 wt %; or 0.1 wt % to 10 wt %; or 0.1 wt % to 5 wt %; or 0.1 wt % to 1 wt %; or 0.1 wt % to 0.5 wt %; or 0.5 wt % to 25 wt %; or 0.5 wt % to 20 wt %; or 0.5 wt % to 15 wt %; or 0.5 wt % to 10 wt %; or 0.5 wt % to 5 wt %; or 0.5 wt % to 1 wt %; or 1 wt % to 25 wt %; or 1 wt % to 20 wt %; or 1 wt % to 15 wt %; or 1 wt % to 10 wt %; or 1 wt % to 5 wt %; or 5 wt % to 25 wt %; or 5 wt % to 20 wt %; or 5 wt % to 15 wt %; or 5 wt % to 10 wt %.

The vegetable oils can be one or more drying oils, semi-drying oils and non-drying oils. Examples include almond oil, cacao oil, candlenut oil, castor oil, dehydrated castor oil, coconut oil, corn oil, cottonseed oil, grape seed oil, hempseed oil, linseed oil, olive oil, palm kernel oil, peanut oil, rapeseed oil, rice bran oil, safflower oil, sunflower oil, sesame oil, soybean oil, tall oil, tung oil and walnut oil, including combinations and fatty acid esters, such as fatty acid alkyl esters thereof.

Alternatively, the oil can be one or more fatty acid alkylester, as for example rapeseed methylester, rapeseed isopropylester, caprylic acid methylester, capric acid isoproplyester, laurylic acid methylester, myristic acid methylester, palmitic acid methylester, stearic acid methylester, oleic acid ethylester, erucic acid methylester, ricinoleic acid methyl ester, linoleic acid ethyl ester, linolenic acid methyl ester or palmitic acid isopropylester.

### Alkyd Resin

The radiation-curable hybrid ink or coating compositions of the invention may further comprise one or more alkyd resins. When present, the one or more alkyd resins may be present in an amount of 1 wt % to 15 wt %, based on the total weight of the ink or coating composition. The one or more alkyd resins are preferably present in an amount of 1 wt % to 12 wt %; such as 2 wt % to 10 wt %; and more preferably in an amount of 3 wt % to 8 wt %; and even more preferably 5 to 8 wt %.

The one or more alkyd resins may also be present in an amount of 1 wt % to 5 wt %; or 1 wt % to 3 wt %; or 1 wt % to 2 wt %; or 2 wt % to 15 wt %; or 2 wt % to 12 wt %; or 2 wt % to 10 wt %; or 2 wt % to 8 wt %; or 2 wt % to 5 wt %; or 2 wt % to 3 wt %; or 3 wt % to 15 wt %; or 3 wt % to 12 wt %; or 3 wt % to 10 wt %; or 3 wt % to 8 wt %; or 3 wt % to 5 wt %; or 5 wt % to 15 wt %; or 5 wt % to 12 wt %; or 5 wt % to 10 wt %; or 5 wt % to 8 wt %.

Alkyds are polyesters modified by the addition of vegetable oil, fatty acids and other components and therefore are partly derived from, vegetable oil (or as used herein are “vegetable alkyds”). In the ink of the present invention, alkyds typically have number average molecular weights of 1,000 to 20,000 Da.

The alkyds for use in the invention may be the reaction product between a polyhydric alcohol and an acid or acid anhydride. The alkyd for use in the invention is a vegetable alkyd The alkyds for use in the invention may be modified with fatty acids, either saturated or unsaturated, from plant and vegetable oils. Non-limiting examples of such acids include sebatic acid, lauric acid, stearic acid, myristic acid, palmitic acid, oleic acid, linoleic acid, arachidic acid, behenic acid, erucic acid, linolic acid, linoelaidic acid, eleostearic acid, timnodonic acid, arachidonic acid, clupanodonic acid, ricinolic acid, ricinelaidic acid, versatic acid, citric acid, oxalic acid, malonic acid, succinic acid, glutaric acid, maleic acid, fumaric acid, phthalic acid, isophthalic acid, terephthalic acid, trimellitic acid, combinations thereof, and the like.

The alkyds for use in the invention may be produced with vegetable oil which has been trans-esterified through the addition of a polyol. The polyol may be glycerol. The vegetable oil may be tall oil. The alkyds for use in the invention may include soya oil, sunflower oil, rapeseed oil, corn oil, tung oil, linseed oil, coconut oil and palm oil. The alkyd for use in the invention may be any combination of those alkyds mentioned above.

The lithographic radiation-curable hybrid ink or coating compositions of the present invention preferably comprise vegetable oils, vegetable oil esters, and vegetable alkyd resins in an amount between 0.1 and 30 wt % and more preferably in an amount between 10 and 25 wt %.

### Colorants

The radiation-curable hybrid ink and coating compositions of the present invention may further comprise one or more colorants in the form of a pigment. When present, the one or more colorants are present in an amount of 1 wt % to 20 wt %, based on the total weight of the ink or coating composition, and preferably between 5 wt % and 18 wt %, and more preferably between 10 wt % and 15 wt %.

For example, the one or more colorants may be present in an amount of 1 wt % to 15 wt %; or 1 wt % to 10 wt %; or 1 wt % to 5 wt %; or 1 wt % to 3 wt %; or 1 wt % to 2 wt %; or 2 wt % to 20 wt %; or 2 wt % to 15 wt %; or 2 wt % to 10 wt %; or 2 wt % to 5 wt %; or 2 wt % to 3 wt %; or 5 wt % to 20 wt %; or 5 wt % to 15 wt %; or 5 wt % to 10 wt %; or 10 wt % to 20 wt %; or 10 wt % to 15 wt %; or 15 wt % to 20 wt %.

Pigments suitable for use in the present invention include conventional organic or inorganic pigments. Representative pigments include, but are not limited to, Pigment Yellow 1, Pigment Yellow 3, Pigment Yellow 12, Pigment Yellow 13, Pigment Yellow 14, Pigment Yellow 17, Pigment Yellow 63, Pigment Yellow 65, Pigment Yellow 73, Pigment Yellow 74, Pigment Yellow 75, Pigment Yellow 83, Pigment Yellow 97, Pigment Yellow 98, Pigment Yellow 106, Pigment Yellow 111, Pigment Yellow 114, Pigment Yellow 121, Pigment Yellow 126, Pigment Yellow 127, Pigment Yellow 136, Pigment Yellow 138, Pigment Yellow 139, Pigment Yellow 174, Pigment Yellow 176, Pigment Yellow 188, Pigment Yellow 194, Pigment Orange 5, Pigment Orange 13, Pigment Orange 16, Pigment Orange 34, Pigment Orange 36, Pigment Orange 43, Pigment Orange 61, Pigment Orange 62, Pigment Orange 64, Pigment Red 2, Pigment Red 9, Pigment Red 14, Pigment Red 17, Pigment Red 22, Pigment Red 23, Pigment Red 37, Pigment Red 38, Pigment Red 41, Pigment Red 42, Pigment Red 48:2, Pigment Red 53:1, Pigment Red 57:1, Pigment Red 81:1, Pigment Red 112, Pigment Red 122, Pigment Red 170, Pigment Red 184, Pigment Red 210, Pigment Red 238, Pigment Red 266, Pigment Blue 15, Pigment Blue 15:1, Pigment Blue 15:2, Pigment Blue 15:3, Pigment Blue 15:4, Pigment Blue 61, Pigment Green 7, Pigment Green 36, Pigment Violet 1, Pigment Violet 19, Pigment Violet 23, Pigment Black 7, combinations thereof, and the like.

### Photoinitiators

The radiation-curable hybrid ink and coating compositions of the present invention may further comprise, if cured by UV-light, one or more photoinitiators. When present, the one or more photoinitiators may be incorporated in an amount of between 0.1 wt % to 20 wt %, based on the total weight of the ink or coating composition. For example, the one or more photoinitiators are preferably present in an amount of 0.1 wt % to 15 wt %; such as 0.5 wt % to 15 wt %; or more preferably 1 wt % to 10 wt %; such as even more preferably 4 to 8 wt %.

The photoinitiators may also be present in an amount of or 0.1 wt % to 3 wt %; or 0.1 wt % to 1 wt %; or 0.1 wt % to 0.5 wt %; or 0.5 wt % to 20 wt %; or 0.5 wt % to 15 wt %; or 0.5 wt % to 10 wt %; or 0.5 wt % to 5 wt %; or 0.5 wt % to 1 wt %; or 1 wt % to 20 wt %; or 1 wt % to 15 wt %; or 1 wt % to 10 wt %; or 1 wt % to 5 wt %; such as 1 wt % to 3 wt %; or 1 wt % to 2 wt %.

Examples of suitable photoinitiators include, but are not limited to, benzophenones, benzilketales, dialkoxy acetophenones, hydroxyalkyl-acetophenones, aminoalkylphenones, acylphosphinoxides and thioxanthones, for example benzophenone, methylbenzophenone, 4-phenylbenzophenone, 4,4′-bis(dimethylamino)-benzophenone, 4,4′-bis(diethylamino)-benzophenone, 2,2-dimethoxy-2-phenylacetophenone, dimethoxyacetophenone, diethoxy-acetophenone, 2-hydroxy-2-methyl-1-phenylpropan-1-one, 2-benzyl-2-dimethylamino-1-(4-morpholinophenyl)-butan-1-one, 2-methyl-1-[4 (methoxythio)-phenyl]-2-morpholinopropan-2-one, diphenylacylphenyl phosphinoxide, diphenyl(2,4,6-trimethylbenzoyl) phosphinoxide, 2,4,6-trimethylbenzoylethoxyphenyl phosphinoxide, 2-isopropylthioxanthone, 4-isopropylthioxanthone, 2,4-dimethylthioxanthone or mixtures thereof. In the case of EB-curable inks, photoinitiators are not required.

Preferred photoinitiators include the Type II photoinitiators thioxanthones such as 2-isopropyl thioxanthone and 2,4-diethylthioxanthone, the Type II photoinitiator 2-dimethylamino-2-(4-methyl-benzyl)-1-(4-morpholin-4-yl-phenyl)-butan-1-one, and the Type I photoinitiators based on phosphinates, such as ethyl(2,4,6-trimethylbenzoyl)-phenyl-phosphinate.

For an ink designed for food packaging, migrating low molecular weight monomeric photoinitiators can be minimized, or completely replaced by oligomeric or polymeric photoinitiators. Suitable photoinitiators are, for example, photoinitiators containing oligomeric benzophenone derivatives such as for example Omnipol BP from IGM resins, oligomeric amines such as for example Genopol AB-1 from Rahn Group or oligomeric type-I-photo initiators such as Omnipol 910 from IGM company.

### Other Optional Additives

In order to avoid premature polymerization of the double-bonds in the oils and alkyd resin, an antioxidant can be added. Exemplary anti-oxidants include ascorbic acid, astaxanthin, carotene, chroman (3,4-dihydro-2H-1-benzopyran), hexamethylene bis(3,5-di-tert-butyl-4-hydroxyhydro-cinnamate), octadecyl 3,5-di-tert-butyl-4-hydroxyhydro-cinnamate, vitamin E and vitamin E analogs, mono-tert-butylhydroquinone (MTBHQ) and butylated hydroxy toluene (BHT). Preferred anti-oxidants are MTBHQ and BHT. When present, antioxidants are typically present in an amount of 0.1 wt % to 4 wt %, based on the total weight of the ink or coating composition. For example, the one or more antioxidants may be present in an amount of 0.1 wt % to 3 wt %; preferably 0.1 wt % to 2 wt %; or more preferably 0.1 wt % to 1.1 wt %.

The antioxidant may also be present in amount such as 0.1 wt % to 0.5 wt %; or 0.5 wt % to 4 wt %; or 0.5 wt % to 3 wt %; or 0.5 wt % to 2 wt %; or 0.5 wt % to 1 wt %; or 1 wt % to 4 wt %; or 1 wt % to 3 wt %; or 1 wt % to 2 wt %; or 2 wt % to 4 wt %; or 2 wt % to 3 wt %; or 3 wt % to 4 wt %.

In order to accelerate the drying of oils and alkyds, the ink may contain one or more dryers, which are typically fatty acid salts, such as heavy metal salts (e.g. manganese) of organic carboxylic acids. Examples of these heavy metal salts of organic carboxylic acids include, but are not limited to, manganese linoleate, hexadecanoate or octoate (e.g., see U.S. Pat. Nos. 5,156,674; 6,899,756; 7,811,367). The dryer can be any of the commercially available metal dryers. When present, the one or more dryers are typically present in an amount of 0.1 wt % to 3 wt %, based on the total weight of the ink or coating composition. For example, the one or more dryers may be present in an amount of 0.1 wt % to 2 wt %; or 0.1 wt % to 1 wt %; or 0.1 wt % to 0.5 wt %; or 0.5 wt % to 3 wt %; or 0.5 wt % to 2 wt %; or 0.5 wt % to 1 wt %; or 1 wt % to 3 wt %; or 1 wt % to 2 wt %; or 2 wt % to 3 wt %.

The hybrid inks and coatings of the present invention may further contain the usual additives to modify flow, surface tension, gloss, pigment wetting and abrasion resistance of the cured coating or printed ink. Such additives contained in inks or coatings typically are surface-active agents, waxes, shelf-life stabilizers, etc. and combinations thereof. These additives may function as leveling agents, shelf-life stabilizers, wetting agents, slip agents, flow agents & dispersants. Preferred additives include fluorocarbon surfactants, silicones and organic polymer surfactants. Examples include the Tegorad product lines (Tegorad are trademarks and are commercially available products of Tego Chemie, Essen, Germany) and the Solsperse product lines (Solsperse are trademarks and are commercially available products of Lubrizol Company). When present, these one or more additives are generally present in an amount of 0.1 wt % to 4 wt %, based on the total weight of the ink or coating composition. For example, the one or more antioxidants may be present in an amount of 0.1 wt % to 3 wt %; or 0.1 wt % to 2 wt %; or 0.1 wt % to 1 wt %; or 0.1 wt % to 0.5 wt %; or 0.5 wt % to 4 wt %; or 0.5 wt % to 3 wt %; or 0.5 wt % to 2 wt %; or 0.5 wt % to 1 wt %; or 1 wt % to 4 wt %; or 1 wt % to 3 wt %; or 1 wt % to 2 wt %; or 2 wt % to 4 wt %; or 2 wt % to 3 wt %; or 3 wt % to 4 wt %.

The hybrid inks and coatings of the present invention synthetic may comprise between 1 and 15 wt % of one or more biobased waxes. The hybrid inks and coatings of the present invention synthetic preferably comprise between 2 and 10 wt % of one or more biobased waxes. Biosourced waxes for use in the invention include those based on carnauba, sugar cane, polylactic acid, rice bran, hydrogenated castor oil, and poly-(hydroxybutyrate-co-hydroxyvalerate) PHVB.

The radiation-curable hybrid ink of the present invention may further contain the usual extenders such as clay, talc, calcium carbonate, magnesium carbonate or silica to adjust water pickup, misting and color strength. When present, the one or more extenders or fillers are typically present in an amount of 1 wt % to 10 wt %, based on the total weight of the ink or coating composition. For example, the one or more extenders or fillers may be present in an amount of 1 wt % to 8 wt %; or 1 wt % to 5 wt %; 1 wt % to 4.5 wt %; or 1 wt % to 4 wt %; or 1 wt % to 3.5 wt %; or 1 wt % to 3 wt %; or 1 wt % to 2.5 wt %; or 1 wt % to 2 wt %; or 1 wt % to 1.5 wt %; or 2 wt % to 10 wt %; or 2 wt % to 8 wt %; or 2 wt % to 5 wt %; or 2 wt % to 4.5 wt %; or 2 wt % to 4 wt %; or 2 wt % to 3.5 wt %; or 2 wt % to 3 wt %; or 2 wt % to 2.5 wt %; or 3 wt % to 10 wt %; or 3 wt % to 8 wt %; or 3 wt % to 5 wt %; or 3 wt % to 4.5 wt %; or 3 wt % to 4 wt %; or 3 wt % to 3.5 wt %; or 4 wt % to 10 wt %; or 4 wt % to 8 wt %; or 4 wt % to 5 wt %.

The hybrid inks and coatings of the present invention synthetic preferably comprise less than 5 wt % of synthetic waxes, such as PE or PTFE wax. The hybrid inks and coatings of the present invention synthetic are more preferably substantially free of synthetic waxes, such as PE or PTFE wax.

### Printed Articles

The present invention also provides a printed article comprising the lithographic radiation curable hybrid ink or coating composition of the invention and a substrate. Examples of such articles include, but are not limited to, those comprising substrates selected from paper, plastic, plastic or polymer film, glass, ceramic, metal, composites, and the like. The articles also include products of manufacture, such as publications (e.g. brochures), labels, and packaging materials (e.g. cardboard sheet or corrugated board), containers (e.g. bottles, cans), a polyolefin (e.g. polyethylene or polypropylene), a polyester (e.g. polyethylene terephthalate), a metalized foil (e.g. laminated aluminum foil), metalized polyester, a metal container, and the like.

The substrate to be printed on may be composed of any typical substrate material such as paper and carton board. The substrate may be paper print stock typically used for publications or may be a packaging material in the form of a cardboard sheet or corrugated board.

### Curing the Hybrid Inks and Coatings of the Invention

The radiation-curable inks and coatings of the present invention can be cured by an actinic light source, such as for example UV-light, provided by a high-voltage mercury bulb, a medium-voltage mercury bulb, a xenon bulb, a carbon arc lamp, a metal halide bulb, a UV-LED lamp or sunlight. The wavelength of the applied irradiation is preferably within a range of 200 to 500 nm, more preferably 250 to 350 nm. UV energy is preferably within a range of 30 to 3,000 mJ/cm², and more preferably within a range of 50 to 500 mJ/cm². In addition, the bulb can be appropriately selected according to the absorption spectrum of the radiation-curable composition.

Alternatively, actinic radiation may also include electron beam radiation (EB). Commercially, EB-dryers are available for example from Energy Science, Inc. of Wilmington, Mass, or from Advanced Electron Beams Inc. (AEB) of Wilmington, Mass. The energy absorbed, also known as the dose, is measured in units of kilo-Grays (kGy), one kGy being equal to 1,000 Joules per kilogram. Typically, the electron beam dose should be within the range of 10 kGy to 40 kGy for complete curing. With the radiation-curable composition of the present invention, preferably curing with a radiation dose of 20-30 kGy at an oxygen level of <200 ppm is usually sufficient to get a dry, solvent resistant ink.

Optionally, an infrared or thermal dryer on press can be used to accelerate the setting of the oil components.

### Preparation of Radiation-Curable Hybrid Inks and Coatings

The ink can be made by typical procedures known in the art, usually by dry-grinding or using a flush, color concentrate, or base. In a typical dry-grind manufacturing procedure for inks, the required amount of dry pigment is mixed with conventional oils, alkyd resin, inert hard resins solubilized in vegetable oils in a dissolver or mixer for 15-30 minutes to wet out all pigment. The pre-mix is then ground on a three roll mill (or other grinding mill) at a pressure of 1-4 MPa and a temperature of 20-40° C. until the desired grind specifications are met. Photoinitiators can be added before or after grinding in the form of a solution or paste.

The pigment may be introduced as a flush. In the “flushing process” the wet pigment press cake is “flushed” in high shear grinding equipment like, for example, a sigma blade mixer. Oil, varnish, alkyd and/or other non-aqueous hydrophobic vehicles are added, and the pigment will eventually flush into the organic phase and leave the water phase clear of pigment. A substantial part of the water can then be poured off. In order to remove the remaining water, usually heat and vacuum is applied. The resulting product is called a “flush paste” or pigment concentrate (base). Then, the pigment concentrate is diluted with acrylate monomer, oligomer, optional photoinitiator and solution of inert hard resin (varnish).

This is preferred from the viewpoint of versatility. A color concentrate which is used for a cold-set ink, a heat-set ink or a sheet-fed ink, is highly appreciated by a formulator provided that he could use it also in a UV-hybrid ink.

### EXAMPLES

The following examples illustrate specific aspects of the present invention and are not intended to limit the scope thereof in any respect and should not be so construed.

### Measurement Methods

### Molecular Weight:

The molecular weight of non-polymeric or oligomeric compounds (e.g. monomers) is defined and calculated by the molecular structure of the compound. Usually, this is given by the supplier technical data sheet of the monomer or can be found on the webpage of the European Chemical Agency (ECHA).

The molecular weight of oligomeric and polymeric species is measured by Gel Permeation Chromatography (GPC) conducted on a Hewlett-Packard 1050 Series HPLC system equipped with two GPC Ultrastyragel columns, 103 and 104 Å (5 μm mixed, 300 mm×19 mm, Waters Millipore Corporation, Milford, MA, USA) and THE as the mobile phase. The column temperature is 40° C. The molecular weight is calculated by comparison with a polystyrene standard. The skilled person will appreciate that this definition of molecular weight applies to polymeric materials which typically have a molecular weight distribution. Unless otherwise stated, the molecular weight reported herein for oligomers and polymers is the number average molecular weight.

### Biobased/Biorenewable Content

The biobased/biorenewable carbon content (BRC) is determined using the standard method described in ASTM D6866 (“Standard Test Methods for Determining the Biobased Content of Natural Range Materials Using Radiocarbon and Isotope Ratio Mass Spectrometry Analysis”), Method B. See “Understanding biobased carbon content,” Society of the Plastics Industry Bioplastics Council (February 2012). The application of ASTM D6866 to measure “biobased content” is based on the same concepts as radiocarbon dating, but without using the age equations. The ratio of the amount of radiocarbon (14C) in an unknown sample to that of a modem reference standard is determined. Fossil carbon contains no radiocarbon. The greater the amount of “new” carbon, the higher 14C. The ratio is reported as a percentage of the total carbon that is modem carbon, with the units “pMC” (percent modem carbon), or BRC (as a percentage). Some suppliers may assess a percentage of biobased content based on weight, based on the “recipe” the producer uses (i.e. how much of a natural material, such as cellulose, is present in a varnish containing cellulose and copolyester). However, it should be noted that the weight percent includes not just the contribution to the weight from the carbon, but also from the other elements in the materials.

For the purposes of the present invention, the BRC content refers to the BRC as assessed using ASTM D6866, Method B.

### Carcinogenic, Mutagenic, or Reprotoxic (CMR) Compounds

CMR compounds are classified according to the EU Classification, Labelling and Packaging of substances (CLP) Regulation 1272/2008. CMR compounds are those falling under categories 1A, 1B, and 2 of this EU classification.

Phenolic Modified Rosin Resin may be made from the esterification of glycerol (or pentaerythritol) with the polycondensate of rosin, phenol (or bisphenol A) and formaldehyde.

### Viscosity

Viscosity was determined with a MCR301 cone and plate rheometer from Anton Paar GmbH at a shear rate of D=2-50 l/s at 23° C. The viscosity value at D=50 l/s was recorded (Pa·s) and yield value at D=2 l/s.

### Tack

Inkometer tack was measured with a calibrated “Inkometer” instrument from Thwing Albert. 1.30 cm³ of ink was placed on the EPDM rubber distribution roller at 32.2° C., distributed for 15 seconds at a roller speed of 150 rpm, then 60 seconds at 800 rpm.

The integrated tack (iTack) was also measured with a Alphatack from Novomatics using 100 μL sample at 30° C. and 800 rpm. The measured value (iTack value) is read after 60 s.

### Flow

The flow was measured with a vertically arranged aluminum plate at 90° on which 1 ml of ink was placed. The distance in cm that the ink ran down the plate after 15 minutes was recorded.

### Misting

Misting was assessed in two ways. Misting quotation is determined by visual assessment against a internal scale made with real example. Firstly, a visual assessment (visual cotation) is used and a value of between 0 (perfect), 1 (very good), 2 (good), 3 (acceptable), 4 (poor), and 5 (very poor) is obtained. A result of less than 3 is considered acceptable. Secondly, an “Inkometer” from Thwing Albert is used, using 3.5 g of ink placed on the EPDM rubber distribution roller at 32° C., distributed for 15 seconds at a roller speed of 150 rpm, then 5 minutes at 2000 rpm. A blank paper sheet is placed behind the rollers during the test. The inkometer measures the optical density (OD) of the ink on the paper sheet.

### Gloss

Gloss was measured using a Micro Gloss Instrument from BYK-Gardner, set at an angle of 60 degrees. Gloss is reported as gloss units.

### Assessment of Cure

The cure of a print was assessed by how much ink from a cured print was transferred (set-off) to another piece of paper under high pressure. This simulates the condition in a large paper stack or substrate roll where the freshly cured prints are stored under pressure.

Ideally, no ink is transferred. Usually, the transfer of an experimental ink to the test paper is compared relative to the transfer of a control UV ink to the test paper, wherein the control ink is intended for the same application The amount of set-off ink at a defined UV-dose is a measure for the reactivity and achievable cure speed (productivity).

The cure of the ink is assessed by the set-off test, employed by the following method: the ink was applied onto a surface of a cardboard substrate with a print proofer in an appropriate optical density (OD). OD is measured by a densitometer. Suitable printed optical densities for lithographic inks are 0.9-1.5 (yellow), 1.0-1.65 (cyan), 1.0-1.5 (magenta), and 1.1-1.9 (black), depending on the substrate. Directly after UV-cure with a 200 Watt Fusion H-bulb at a line speed of 400 feet/min, delivering a UV-dose of 33 mJ/cm², the reverse surface of a paper board substrate (Invercote G-3×3 cm²) was applied on the cured ink sample. Both were introduced on a press and a pressure of 1000 bars (10 tonnes (1000 Kg) per cm²) was applied. The print was released as soon as the pressure was reached (1-second pressure time). The set off material (transferred ink) on the board substrate was measured with a Techkon Densitometer and compared to a control ink.

By comparing to a control ink, under the same curing conditions and printed density, the ink with a lower number on the densitometer indicates better cure. A densitometer reading lower than 0.50 is usually considered a good value.

### Ink Grinding Test

Fineness of ink grind is an important parameter that describes the quality of dispersion of solid pigment particles in the ink. A grindometer was used to test the fineness of the pigment particles. The grindometer consists of a steel block with a channel of varying depth machined into it, starting at a convenient depth for the type of ink to be measured, and becoming shallower until it ends flush with the block's surface. The depth of the groove is marked off on a graduated scale next to it. The ink to be tested was poured into the deep end of the groove and scraped towards the shallow end with a flat metal scraper. At the point of 4 μm on the graduated scale, the ink track was inspected for the number of large irregularities (first number in bracket), and the number of small irregularities (second number in bracket). A score of (0/0) means that there are neither large particles nor small irregularities observed, and the ink is rated as having passed.

All inks according to the invention have acceptable ink grinding properties, with particle size below 15 μm.

### Stability

Stability was tested using two methods.

The first method utilizes a Turbiscan Static Multiple Light Scattering (SMLS) analyser to detect particle migration and size variation. The analyser uses an oven set to 50° C. into which samples of the same concentration are placed. Two synchoronous detectors were used to analyse both the backscattering (BS) and Transmission (T) signals of laser light incident on the samples, with scans made over the entire length of the sample and measurements taken periodically over a period of time up to 9 days, 20 hours. Variation in the Backscattering (ΔBS (%)) over time is indicative of instability in the ink, with greater variation corresponding to greater instability (due to the particles settling). The Turbiscan Stability Index (TSI) is determined from the sum of the T and BS variations over the whole height of the sample and is plotted as a function of time. Lower TSI indicates increased stability of the sample.

The second method utilizes Rheolaser Technology based on Multi Speckle Diffusing Wave

Spectroscopy (MS-DWS) to analyse the rheological properties of samples without mechanical stress (by passive microrheology). The backscattering (BS) of laser light is measured for samples of the same concentration, during six cycles of temperature. The same temperature ramp rate is employed in each of the six cycles making up one experiment. The response is measured in MicroDynamics (mD) in Hz. Three different temperature ramp rates are employed: a) 10 to 50° C. at 10° C./min, b) 10 to 50° C. at 5° C./min, c) 10 to 40° C. at 10° C./min. The Speckle Image obtained is analysed mathematically to obtain a characteristic time as a function of time. The characteristic time is inversed to obtain the mD and the results plotted as a function of time. Consistent mD response over multiple cycles indicates stability. In contrast, increasing or decreasing mD response with increasing number of cycles indicates a lack of stability.

### Examples 1 and 2. Cyan Hybrid Inks Containing 16 to 22% Inert Hard Resin

Inventive cyan hybrid inks were made from dry grind on a three rolls mill, 3 passes at 2 MPa (25° C.), having the composition shown in Table 1 (between 16%-22% inert hard resin).

TABLE 1
Examples 1 and 2

| | BRC | Example 1 | Example 2 |
|---|---|---|---|
| Raw Materials | (%) | (weight %) | (weight %) |
| ¹ Conventional varnish (Modified phenolic resin in | 100 | 36.0 | 36.0 |
| vegetable oils, alkyds and soya oil methyl ester) | | | |
| ² Inert resin varnish | 18.13 | | 15.0 |
| Hexafunctional Polyester acrylate³ | 25.0 | 27.2 | 7.5 |
| Difunctional Aliphatic polyester urethane acrylate⁴ | 56.0 | | 6.5 |
| Photoinitiator Ethyl(2,4,6-trimethylbenzoyl)-phenyl- | 0 | 1.6 | 1.6 |
| phosphinate | | | |
| Photoinitiator 2-dimethylamino-2-(4-methyl-benzyl)- | 0 | 1.6 | 1.6 |
| 1-(4-morpholin-4-yl-phenyl)-butan-1-one | | | |
| Photoinitiator 2-Isopropyl Thioxanthone | 0 | 0.4 | 0.4 |
| Photoinitiator 2,4-Diethylthioxanthone | 0 | 0.4 | 0.4 |
| Multifunctional aminobenzoate derivative | 0 | 4.0 | 4.0 |
| ⁵ Vegetable based Wax compound | 55.0 | 8.0 | 8.0 |
| Micronized talc | 0 | 3.0 | 1.2 |
| Fumed silica | 0 | 1.5 | 1.5 |
| Levelling agent | 0 | 1.0 | 1.0 |
| Slip agent | 0 | 0.3 | 0.3 |
| BHT | 0 | 1.0 | 1.0 |
| SunFast Blue 249-1256 (PB15:3) | 0 | 14.0 | 14.0 |
| Total | | 100.0 | 100.0 |

| | | |
|---|---|---|
| BRC calculation (%) | 47.20 | 48.63 |

¹ 44.5 wt % Modified phenolic resin, 12.5 wt % Linseed oil, 21 wt % soya oil, 21.5 wt % soya oil methyl ester, 0.5 wt % antiox solution (20 wt % BHT in soya oil)
² 40 wt % DiAllyl Phtalate resin solubilized in 15 wt % Lauryl acrylate and 45 wt % propoxylated glycerin triacrylate (GPTA). GPTA is 3.5 times propoxylated and has a molecular weight of 430 gmol⁻¹ (i.e. oligomeric).
³Ebecryl Leo 10801, number average molecular weight = 1500 g/mol (i.e. oligomeric).
⁴Genomer 4293: biobased, number average molecular weight = 2300 g/mol (i.e. oligomeric).
⁵ Vegetable wax compound: 40 wt % rice bran wax + 60 wt % hexa-functional Polyester acrylate (Ebecryl Leo 10801, number average molecular weight = 1500 g/mol) (i.e. oligomeric).

The properties of Example 1 and 2 inks were tested as described above. The results are shown in Table 1A.

TABLE 1A
Properties of Examples 1 and 2

| | Example 1 | Example 2 |
|---|---|---|
| Viscosity [Pa*s] @50 s−1 | 31.1 | 36.7 |
| Yield [Pa*s] @2 s−1 | 67.8 | 80.8 |
| Inkometer tack [g · m] | 15.6 | 23.2 |
| iTack (Lithotack) (N/m) | 255.7 | 381.1 |
| Flow after 15 min. [cm] | 2.2 | 1.8 |
| Set-off UV-curing test | 0.02 | 0.10 |
| curing @ ¹OD 1.45 | | |
| Misting (visual cotation/ | (5/0.23) | (4/0.20) |
| measured OD) | | |

¹Optical density of printed ink on printed substrate.

The Example 1 and 2 inks, as shown in Table 1A, exhibit typical values of viscosity (20-60 Pas), flow (1.5-7 cm) and tack (10-40 units inkometer and 200-500 units Lithotack) of a UV lithographic ink.

TABLE 2
Example 3 with conventional color bases

| | BRC | Color base 1 | Color base 2 |
|---|---|---|---|
| Raw material | (%) | Weight % | Weight % |
| PR48:2 Irgalite Red D3785 | 0 | 27.5 | |
| PR122 228-0066 Quindo Magenta | 0 | | 24.0 |
| Alkyd | 100 | 11.0 | 15.0 |
| Phenolic resin | 100 | 25.3 | 25.3 |
| Refined linseed oil | 100 | 7.0 | 7.0 |
| Refined soya oil | 100 | 12.0 | 12.0 |
| Soya oil methyl ester | 100 | 15.7 | 14.2 |
| BHT in soya oil (25%) | 75.0 | 1.5 | 2.5 |
| Total | | 100.0 | 100.0 |

| | | |
|---|---|---|
| BRC calculation (%) | 72.13 | 75.38 |

Next, the magenta color base was passed over a three roll mill, 1 pass at 2 MPa (25° C.).

Table 3 below shows the composition of the finished ink (13% inert hard resin, 6.2% alkyd and 18% oil and ester components):

TABLE 3
Example 4 Finished Ink

| Raw Materials | BRC (%) | Weight % |
|---|---|---|
| Table 2 Color base 1 | 72.13 | 41.50 |
| Table 2 Color base 2 | 75.38 | 11.00 |
| Hexafunctional Polyester acrylate³ | 25.00 | 26.70 |
| Photoinitiator Ethyl(2,4,6-trimethylbenzoyl)- | 0 | 1.60 |
| phenyl-phosphinate | | |
| Photoinitiator 2-dimethylamino-2-(4-methyl- | 0 | 1.60 |
| benzyl)-1-(4-morpholin-4-yl-phenyl)-butan-1-one | | |
| Photoinitiator 2-Isopropyl Thioxanthone | 0 | 0.40 |
| Photoinitiator 2,4-Diethylthioxanthone | 0 | 0.40 |
| Multifunctional aminobenzoate derivative | 0 | 4.00 |
| ⁵ Vegetable based Wax compound | 55.00 | 8.00 |
| Micronized talc | 0 | 2.00 |
| Fumed silica | 0 | 1.50 |
| Levelling agent | 0 | 1.00 |
| Slip agent | 0 | 0.30 |
| Total | | 100.00 |

| | |
|---|---|
| BRC calculation (%) | 49.30 |

³Ebecryl Leo 10801, number average molecular weight = 1500 g/mol
⁵ Vegetable wax compound: 40 wt % rice bran wax + 60 wt % hexa-functional Polyester acrylate (Ebecryl Leo 10801, number average molecular weight = 1500 g/mol (i.e. oligomeric))

The properties of Example 4 were tested as described above. The results are shown in Table 3A.

TABLE 3A
Properties of Example 4

| | Example 4 |
|---|---|
| Viscosity [Pa*s] @50 s−1 | 64.2 |
| Yield [Pa*s] @2 s−1 | 129.3 |
| Inkometer tack [g · m] | 22.3 |
| iTack (Lithotack) (N/m) | 366.2 |
| Flow after 15 min. [cm] | 5.9 |

### Example 5. Hybrid Ink Made from Color Base and then UV-Over-Coated (15% Inert Hard Resin)

A hybrid ink was made from a cyan universal base (color concentrate) which can be used to make sheet-fed inks, heat-set inks and cold-set inks and an acrylate let-down varnish by mixing in a dissolver at 40-45° C. for 20 minutes (50% combined inert hard resin & alkyd resin & vegetable oil & mineral oil) and milled on a three-roll mill. The purpose of this experiment is to show that the inks of the present invention are capable of being overprinted with a UV overprint varnish while exhibiting good visual laydown and print properties.

TABLE 4
Example 5 finished ink formulation

| Raw Materials | BRC (%) | Weight % |
|---|---|---|
| ⁶MSB17 cyan universal base (Sun Chemical) | 72.00 | 50.00 |
| ⁷MSB53 violet universal base (Sun Chemical) | 75.28 | 0.50 |
| ⁸Acrylate let-down varnish | 22.30 | 49.50 |
| Total | | 100.00 |

| | |
|---|---|
| BRC calculation (%) | 47.41 |

⁶25% inert hard resin (phenolic modified rosin), 10% alkyd resin, 37% vegetable oils and 28% pigment PB15:3
⁷25% inert hard resin (phenolic modified rosin), 15% alkyd resin, 35% vegetable oils and 25% pigment PV23
⁸Acrylate let down varnish: Polyester hexafunctional acrylate (Ebecryl Leo 10801, number average molecular weight = 1500 g/mol) (i.e. oligomeric); 54.0%, photoinitiator (PI) compound & amine synergist 16%, wax compound 16%, extenders 8%, additives 6%.
The photoinitiator (PI) compound & amine synergist comprises a mixture of phosphine oxides, α-amino ketones, thioxanthones such as 2,4-diethyl thioxanthone, multifunctional aminobenzoate derivatives, and poly(ethylene glycol) bis(p-dimethylaminobenzoate).

The properties of Example 5 were tested as described above. The results are shown in Table 4A.

TABLE 4A
Properties of Example 5

| | Example 5 |
|---|---|
| Viscosity [Pa*s] @50 s−1 | 29.2 |
| Yield [Pa*s] @2 s−1 | 65.5 |
| Inkometer tack [g · m] | 15.8 |
| iTack (Lithotack) (N/m) | 259.0 |
| Flow after 15 min. [cm] | 1.9 |

The ink was printed with on a Roland 700 press (combi rollers from Böttcher and hybrid blanket from Trelleborg; 4% Sunfount 480 and 3% IPA fount) at 12500 sheets/h on Invercote G substrate at 1.45 OD target.

The ink was immediately overprinted with UV-overprint varnish 44HC150 (Sun Chemical) with an anilox roller @140 lines and end-cured with 150 mJ/cm². Gloss was measured as described above. Gloss back is indicated by a decrease in gloss over time. A decrease of less than 10 gloss units indicates that gloss back is within preferred ranges.

TABLE 5
Gloss Back Results

| | Gloss Units |
|---|---|
| Gloss after UV-cure | 31.8 |
| Gloss after 1 day | 32.0 |
| Gloss after 3 days | 32.8 |

Table 5 exhibits that the present hybrid ink is not showing any gloss back.

### Example 6. Cyan Hybrid Ink Made from Conventional Sheetfed Color Base and Gelled Acrylate Varnish Containing 20% Inert Resin

A hybrid ink as shown in Table 6 was made from a cyan conventional sheetfed ink color base and gelled acrylate varnish containing 20% inert resin.

TABLE 6
Example 6

| Raw Materials | BRC (%) | Weight % |
|---|---|---|
| MSB17 cyan universal base (Sun Chemical) | 72.00 | 50.00 |
| MSB53 violet universal base (Sun Chemical) | 75.28 | 0.50 |
| ⁹Gelled acrylate varnish 21CJ95 | 36.25 | 27.50 |
| PI compound & amine synergist | 0 | 8.00 |
| Wax compound | 55.00 | 8.00 |
| Extenders | 0 | 4.00 |
| Additives | 0 | 2.00 |
| Total | | 100.00 |

| | |
|---|---|
| BRC calculation (%) | 50.75 |

⁹71.4% Fatty acid modified polyester acrylate (Agisyn 716, having a molecular weight of 1100 g/mol (i.e. oligomeric); hexafunctional), 24% inert resin for use in the invention, 2.6% gelled agent in sunflower oil, 2% stabilizer

The properties of Example 6 were tested as described above. The results are shown in Table 6A.

TABLE 6A
Properties of Example 6

| | Example 6 |
|---|---|
| Viscosity [Pa*s] @50 s−1 | 58.40 |
| Yield [Pa*s] @2 s−1 | 126.2 |
| Inkometer tack [g · m] | 27.5 |
| iTack (Lithotack) (N/m) | 452.0 |
| Flow after 15 min. [cm] | 3.6 |
| Set-off UV-curing test curing @ ¹OD 1.45 | 0.06 |
| Misting (visual cotation/measured OD) | (4.5/0.22) |

### Stability Testing

The ink of Example 1 was tested (referred to herein as Agricure) as well as a comparative ink (Starluxe), which only comprises acrylate monomers and oligomers but is not a hybrid ink and is therefore free of conventional inert resin components.

### Turbiscan

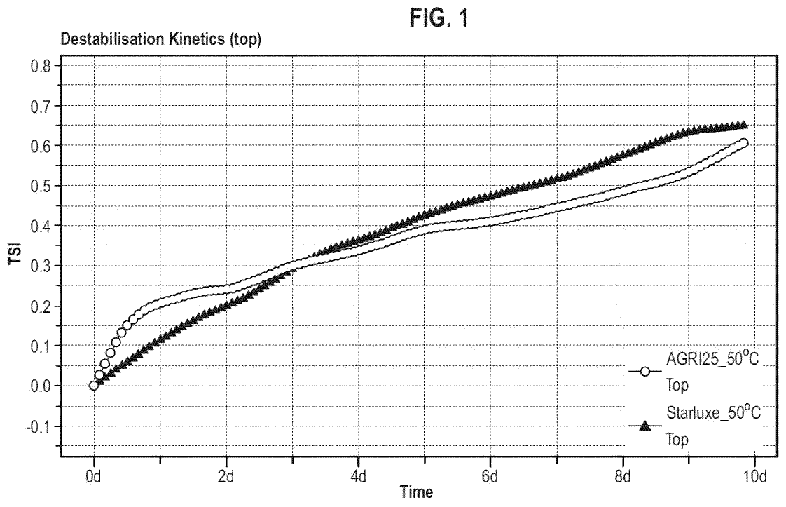

Turbiscan analysis of Example 1 (AgriCure) detected no significant variation in ΔBS (%) for Example 1. In contrast, Turbiscan analysis of Starluxe, which became opaque/clarified over the course of the experiment, detected increased ΔBS (%) variation. FIG. 1 depicts the TSI of both Example 1 and Starluxe, showing how Starluxe evolved more over the course of the experiment, having a higher TSI after 3 days.

### RheoLaser

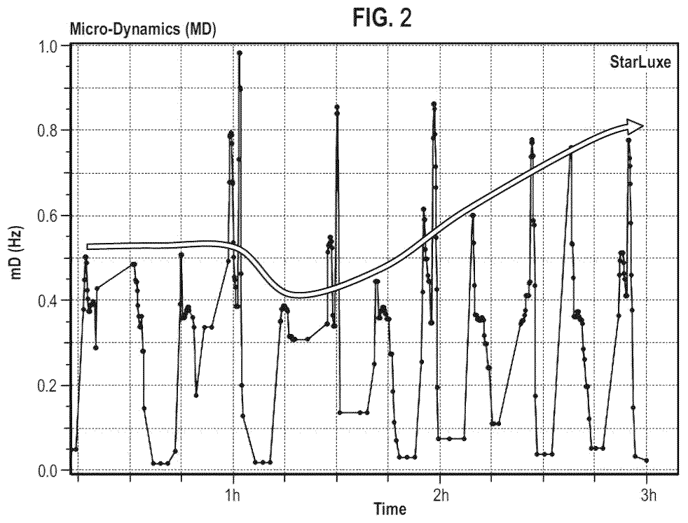

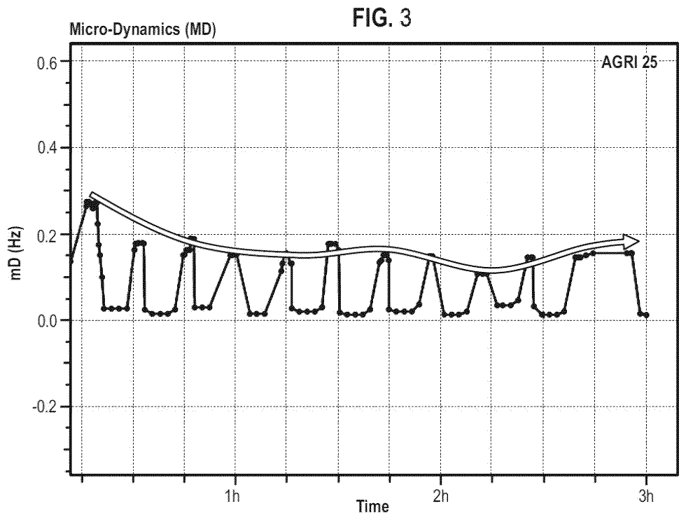

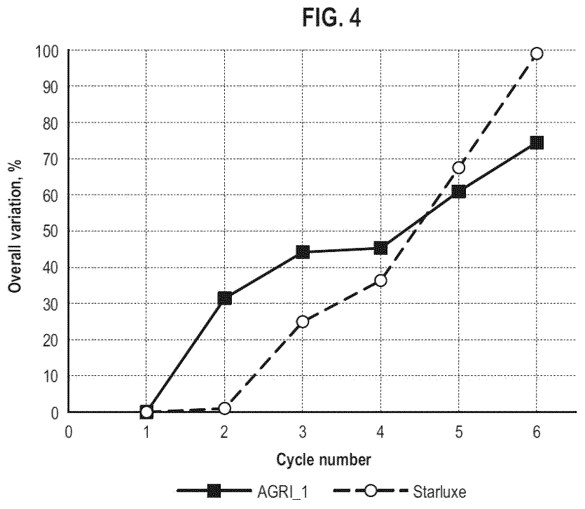

FIG. 2 depicts the results of the RheoLaser analysis of Starluxe under the same conditions, which showed considerably greater variation and noise. Noise is typically an indication of exudation (wherein the liquid layer is on top). In contrast, FIG. 3 depicts the results of the RheoLaser analysis of Example 1 (Agricure) for six temperature cycles between 10 and 50° C. using a 10° C./min ramp rate. A small amount of variation in the mD response was detected. FIG. 4 depicts the percent overall variation (corresponding to the variation in the percentage of the first peak, normalized with respect to the 1st peak of the first cycle).

Variation for Starluxe started slowly but after 4 cycles increased rapidly until after 6 cycles to the percentage overall variation is greater than that for Example 1.

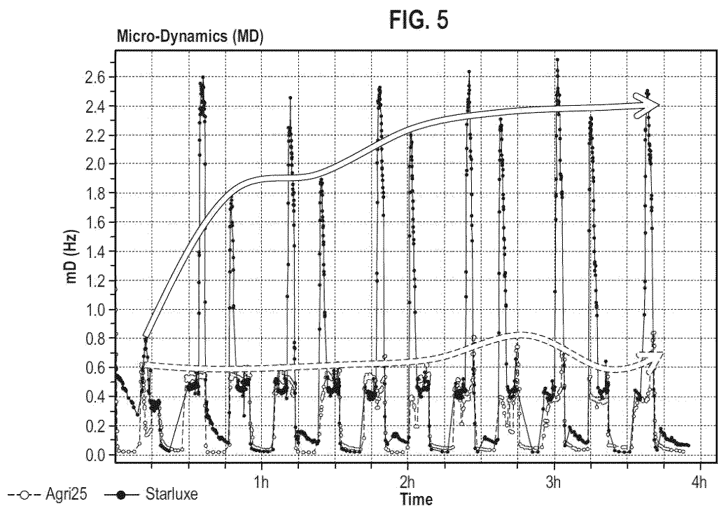

FIG. 5 depicts how similar results were obtained when the analysis was repeated between 10 and 50° C. with a 5° C./min ramp rate.

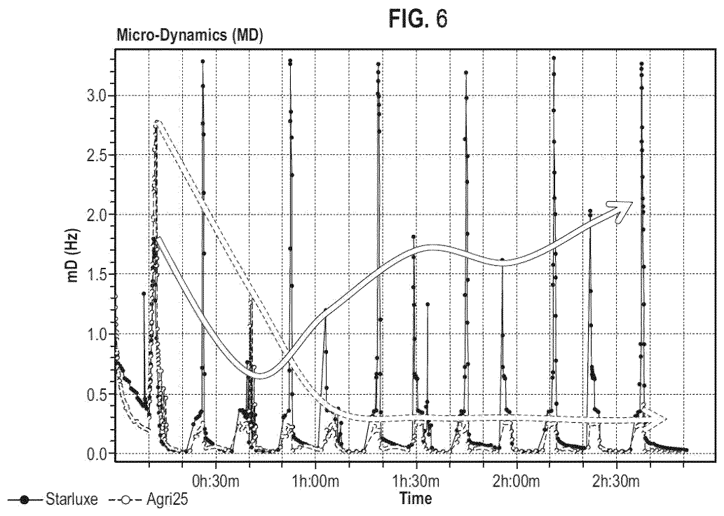

FIG. 6 depicts the results obtained when the analysis was repeated between 1° and 40° C. with a 10° C./min ramp rate. Again considerably greater variation and noise was detected for Starluxe relative to Example 1. In this experiment, some initial variation was observed for Example 1 before the sample stabilized after 1 h.

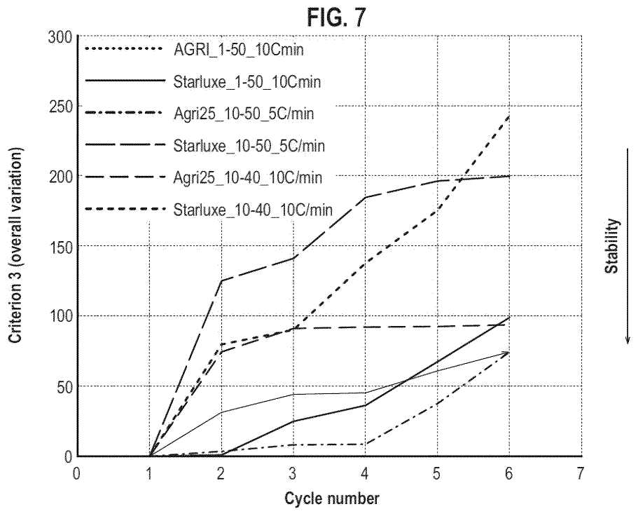

FIG. 7 depicts the results for each of the above mentioned RheoLaser experiments, demonstrating that, for each set of experimental conditions, Example 1 had improved stability (after 6 cycles) than Starluxe, when tested under the same conditions, indicating that Example 1 has improved stability relative to Starluxe.

The present invention has been described in detail, including the preferred embodiments thereof. However, it will be appreciated that those skilled in the art, upon consideration of the present disclosure, may make modifications and/or improvements on this invention that fall within the scope and spirit of the invention.

### Numbered Embodiments of the Invention (Forming Part of the Description

1. A lithographic radiation curable hybrid ink or coating composition comprising:
a) 10 wt % to 30 wt % one or more inert hard resins selected from the group consisting of rosin resins, rosin resin derivatives, iso diallyl phthalate resins, and combinations thereof,
b) 10 to 60% non UV raw material which could be inert hard resin, vegetable oils & esters, vegetable alkyds resins, antioxidant; and
c) 5 wt % to 45 wt % one or more multifunctional acrylate monomers and oligomers;
d) 0-10% monofunctional acrylate monomers and oligomers;
and wherein the ink or coating composition comprises ≥40% BRC.

2. The lithographic radiation curable hybrid ink or coating composition of embodiment 1, wherein the ink or coating composition comprises ≥45% BRC

3. The lithographic radiation curable hybrid ink or coating composition of embodiment 1, wherein the one or more inert hard resins are present in an amount of 10 wt % to 20 wt %.

4. The lithographic radiation curable hybrid ink or coating composition of embodiment 1, wherein the one or more inert hard resins are present in an amount of 10 wt % to 15 wt %.

5. The lithographic radiation curable hybrid ink or coating composition of embodiment 1, wherein the one or more inert hard resins are selected from the group consisting of maleic rosin resins, and combinations thereof.

6. The lithographic radiation curable hybrid ink or coating composition of embodiment 1, wherein at least one of the inert hard resins is a iso diallyl phthalate resin which is soluble in acrylate monomers.

7. The lithographic radiation curable hybrid ink or coating composition of embodiment 1, wherein the one or more inert hard resins are compatible, soluble, or compatible and soluble, with acrylate monomers and oligomers, oils, and alkyd resins.

8. The lithographic radiation curable hybrid ink or coating composition of any one of embodiments 1 to 6, further comprising one or more resins selected from the group consisting of oil-modified phenolic resins, ketone resins, aldehyde-urea resins, oil modified polyester resins, melamine resins, epoxy resins, polyurethane resins, acrylic styrene resins, and combinations thereof.

9. The lithographic radiation curable hybrid ink or coating composition of embodiment 1, wherein the one or more multifunctional acrylate monomers are present in an amount of 5 wt % to 35 wt %.

10. The lithographic radiation curable hybrid ink or coating composition of embodiment 1, wherein the one or more multifunctional acrylate monomers are present in an amount of 5 wt % to 25 wt %.

11. The lithographic radiation curable hybrid ink or coating composition of any one of embodiments 1 to 9, wherein the one or more multifunctional acrylate monomers are selected from the group consisting of 1,2-ethylene glycol diacrylate, 1,4-butandiol diacrylate, 1,6-hexandiol diacrylate, dipropylene glycol diacrylate, neopentylglycol diacrylate, ethoxylated neopentylglycol diacrylates, propoxylated neopentylglycol diacrylates, tripropylene glycol diacrylate, bisphenol-A diacrylate, ethoxylated bisphenol-A-diacrylates, bisphenol-A-diglycidylether diacrylate, ethoxylated bisphenol-A-diacrylates, poly(ethylene)glycol diacrylates, trimethylolpropane triacrylate, trimethylolpropane trimethacrylate, ethoxylated trimethylolpropane triacrylates, propoxylated trimethylolpropane triacrylates, propoxylated glycerol triacrylates, pentaerythritol triacrylate, ethoxylated pentaerythritol triacrylates, propoxylated pentaerythritol tetraacrylates, ethoxylated pentaerythritol tetraacrylates, ditrimethylolpropane tetraacrylate, dipentaerythritol pentaacrylate, dipentaerythritol hexaacrylate, ethoxylated dipentaerythritol hexaacrylates, and combinations thereof.

12. The lithographic radiation curable hybrid ink or coating composition of any one of embodiments 1 to 10, further comprising 0.1 to 30 wt % one or more oils, alkyd resins, or combinations thereof.

13. The lithographic radiation curable hybrid ink or coating composition of embodiment 11, wherein the one or more oils, alkyd resins, or combinations thereof are present in an amount of 1 wt % to 15 wt %.

14. The lithographic radiation curable hybrid ink or coating composition of embodiment 11 or 12, wherein the one or more oils are selected from the group consisting of vegetable oils, fatty acid alkylesters, or combinations thereof.

15. The lithographic radiation curable hybrid ink or coating composition of embodiment 13, wherein the one or more vegetable oils are selected from the group consisting of drying oils, semi-drying oils, non-drying oils, and combinations thereof.

16. The lithographic radiation curable hybrid ink or coating composition of any one of embodiments 1 to 15, further comprising 0.1 wt % to 20 wt % one or more acrylate oligomers.

17. The lithographic radiation curable hybrid ink or coating composition of embodiment 15, wherein the one or more acrylate oligomers are present in an amount of 1 wt % to 10 wt %.

18. The lithographic radiation curable hybrid ink or coating composition of any one of embodiments 15 or 16 wherein each of the one or more acrylate oligomers independently has a number average molecular weight of 400 to 3,000 Daltons, and an acrylate functionality equal to or greater than 2.

19. The lithographic radiation curable hybrid ink or coating composition of any one of embodiments 15 to 17, wherein the one or more acrylate oligomers are chosen from the group consisting of acrylated oils, epoxy acrylates, oil modified polyester acrylates, acrylated polyurethanes, acrylated polyacrylates, acrylated polyethers, acrylated amines, and combinations thereof.

20. The lithographic radiation curable hybrid ink or coating composition of any one of embodiments 1 to 18, further comprising 0.1 wt % to 10 wt % one or more monofunctional acrylate monomers.

21. The lithographic radiation curable hybrid ink or coating composition of embodiment 19, wherein the one or more monofunctional acrylate monomers are present in an amount of 1 wt % to 15 wt %.

22. The lithographic radiation curable hybrid ink or coating composition of any one of embodiments 1 to 20, further comprising 0.1 wt % to 40 wt % of one or more colorants.

23. The lithographic radiation curable hybrid ink or coating composition of embodiment 21, wherein the one or more colorants are present in an amount of 1 wt % to 20 wt %.

24. The lithographic radiation curable hybrid ink or coating composition of embodiment 21 or 22, wherein the one or more colorants are chosen from the group consisting of inorganic pigments, organic pigments, and combinations thereof.

25. The lithographic radiation curable hybrid ink or coating composition of any one of embodiments 1 to 23, further comprising 0.1 wt % to 10 wt % of one or more extenders or fillers.

26. The lithographic radiation curable hybrid ink or coating composition of embodiment 24, wherein the one or more extenders or fillers are present in an amount of 1 wt % to 5 wt %.

27. The lithographic radiation curable hybrid ink or coating composition of embodiment 24 or 25, wherein the one or more extenders or fillers are chosen from the group consisting of clay, talc, calcium carbonate, magnesium carbonate, silica, and combinations thereof.

28. The lithographic radiation curable hybrid ink or coating composition of any one of embodiments 1 to 26, further comprising 0.1 to 20 wt % of one or more photoinitiators.

29. The lithographic radiation curable hybrid ink or coating composition of embodiment 27, wherein the one or more photoinitiators are present in an amount of 1 wt % to 10 wt %.

30. The lithographic radiation curable hybrid ink or coating composition of embodiment 27 or 28, wherein the one or more photoinitiators are chosen from the group consisting of oligomeric photoinitiators, polymeric photoinitiators, and combinations thereof.

31. The lithographic radiation curable hybrid ink or coating composition of any one of embodiments 27 to 29, wherein at least one of the photoinitiators is an oligomeric benzophenone derivative.

32. The lithographic radiation curable hybrid ink or coating composition of any one of embodiments 1 to 30, further comprising 0.1 wt % to 3 wt % of one or more dryers.

33. The lithographic radiation curable hybrid ink or coating composition of embodiment 31, wherein the one or more dryers are each independently selected from the group consisting of fatty acid salts, heavy metal salts of organic carboxylic acid, and combinations thereof.

34. The lithographic radiation curable hybrid ink or coating composition of any one of embodiments 1 to 32, further comprising 0.1 wt % to 5 wt % one or more additives.

35. The lithographic radiation curable hybrid ink or coating composition of embodiment 33, wherein the one or more additives are selected from the group consisting of surface active agents, dispersants, de-aerators, waxes, shelf-life stabilizers, wetting agents, slip agents, flow agents, fluorocarbon surfactants, silicones, organic polymeric surfactants, or combinations thereof.

36. A printed article comprising the lithographic radiation curable hybrid ink or coating composition of any one of embodiments 1 to 34.

1.-49. (canceled)

50. A lithographic radiation curable hybrid ink or coating composition comprising:
a) 10 wt % to 30 wt % one or more inert hard resins selected from the group consisting of rosin resins, rosin resin derivatives, hydrocarbon resins, modified hydrocarbon resins, iso diallyl phthalate resins, non-phthalate allyl resins, and combinations thereof,
b) 10 to 60% non-UV raw material selected from the group consisting of vegetable oils, vegetable oil esters, alkyds resins, antioxidants, and combinations thereof; and
c) 5 wt % to 45 wt % one or more multifunctional (meth)acrylate monomers and/or oligomers;
d) 0-10% monofunctional (meth)acrylate monomers and/or oligomers;
and wherein the ink or coating composition comprises ≥40% biorenewable content, wherein the biorenewable content is measured according to the standard method described in ASTM D6866.

51. The lithographic radiation curable hybrid ink or coating composition of claim 50, comprising less than 5 wt % vegetable oil (meth)acrylates.

52. The lithographic radiation curable hybrid ink or coating composition of claim 50, comprising vegetable oils and vegetable oil esters in an amount of 15 wt % to 35 wt %.

53. The lithographic radiation curable hybrid ink or coating composition of claim 50, wherein the ratio of the amount of inert resins, vegetable oils, vegetable oil esters, and alkyds to the amount of (meth)acrylate monomers and oligomers is at least 0.5:1.0, such as between 0.5:1.0 and 2.0:1.0.

54. The lithographic radiation curable hybrid ink or coating composition of claim 50, comprising between 0 to 20 wt % of one or more photoinitiators.

55. The lithographic radiation curable hybrid ink or coating composition of claim 50, wherein component b) is selected from the group consisting of vegetable oils, vegetable oil esters, alkyds resins, and combinations thereof.

56. The lithographic radiation curable hybrid ink or coating composition of claim 50, wherein the ink or coating composition comprises ≥45% biorenewable content.

57. The lithographic radiation curable hybrid ink or coating composition of claim 50, comprising less than 20 wt % of compounds classified as carcinogenic, mutagenic, or reprotoxic (CMR), preferably less than 10 wt %, or more preferably less than 5 wt %.

58. The lithographic radiation-curable hybrid ink or coating composition of claim 57, wherein the CMR compounds are selected from the group consisting of trimethylolpropane triacrylate, silicone diacrylates, 2-dimethylamino-2-(4-methyl-benzyl)-1-(4-morpholin-4-yl-phenyl)-butan-1-one, and combinations thereof; optionally the CMR compound is trimethylolpropane triacrylate.

59. The lithographic radiation curable hybrid ink or coating composition of claim 50, wherein the one or more inert hard resins of part a) are present in an amount of 10 wt % to 25, such as 10 to 20 wt %.

60. The lithographic radiation curable hybrid ink or coating composition of claim 50, wherein the inert hard resins of part a) are selected from the group consisting of iso diallyl phthalate resin, non-phthalate allyl resins, rosin resin derivatives, and combinations thereof.

61. The lithographic radiation curable hybrid ink or coating composition of claim 50, wherein the one or more inert hard resins of part a) are compatible with, soluble in, or compatible with and soluble in, the (meth)acrylate monomers and oligomers of part c), and the vegetable oils, vegetable oil esters, and vegetable alkyd resins of part b).

62. The lithographic radiation curable hybrid ink or coating composition of claim 50, wherein the (meth)acrylate oligomers of part c) are present in an amount of 0.1 wt % to 45 wt %.

63. The lithographic radiation curable hybrid ink or coating composition of claim 50, wherein the (meth)acrylate oligomers of part c) have a number average molecular weight of at least 400 Daltons, such as between 400 and 3000 Daltons.

64. The lithographic radiation curable hybrid ink or coating composition of claim 50, wherein at least 95 wt % of the (meth)acrylate oligomers present in the ink or coating composition have an acrylate functionality equal to or greater than 2, such as equal or greater than 4, or equal or greater than 6.

65. The lithographic radiation curable hybrid ink or coating composition of claim 50, wherein the (meth)acrylate oligomers of part c) are selected from the group consisting of acrylated oils, epoxy acrylates, polyester acrylates, acrylated polyurethanes, acrylated polyacrylates, acrylated polyethers, acrylated amines, and combinations thereof.

66. The lithographic radiation curable hybrid ink or coating composition of claim 50, wherein the one or more multifunctional (meth)acrylate monomers of part c) are present in an amount of up to 35 wt %.

67. The lithographic radiation curable hybrid ink or coating composition of claim 50, wherein the vegetable oils, vegetable oil esters, and vegetable alkyd resins of part b) are present in an amount between 0.1 and 30 wt %.

68. The lithographic radiation curable hybrid ink or coating composition of claim 50, wherein the vegetable oil esters are vegetable oil fatty acid alkyl esters.

69. The lithographic radiation curable hybrid ink or coating composition of claim 50, wherein the vegetable oils are selected from the group consisting of drying oils, semi-drying oils, non-drying oils, and combinations thereof; optionally wherein the vegetable oils are linseed oil, soya oil, and combinations thereof.

70. The lithographic radiation curable hybrid ink or coating composition of claim 50, comprising 0.1 wt % to 10 wt % of the monofunctional acrylate monomers of part d).

71. The lithographic radiation curable hybrid ink or coating composition of claim 50, comprising 1 to 10 wt % of one or more photoinitiators.

72. The lithographic radiation curable hybrid ink or coating composition of claim 71, wherein the one or more photoinitiators are selected from the group consisting of oligomeric photoinitiators, polymeric photoinitiators, and combinations thereof.

73. The lithographic radiation curable hybrid ink or coating of claim 50, comprising between 1 and 15 wt % of one or more biobased waxes, such as between 2 and 10 wt % of one or more biobased waxes.

74. The lithographic radiation curable hybrid ink or coating of claim 73, wherein the one or more biobased waxes are selected from the list consisting of waxes based on carnauba, waxes based on sugar cane, waxes based on polylactic acid, waxes based on rice bran, waxes based on hydrogenated castor oil, waxes based on poly-(hydroxybutyrate-co-hydroxyvalerate), and combinations thereof.

75. The lithographic radiation curable hybrid ink or coating composition of claim 50, which is substantially free of mineral oil.

76. The lithographic radiation curable hybrid ink or coating composition of claim 50, comprising less than 5 wt % of synthetic waxes, such as wherein the ink or coating composition is substantially free of synthetic waxes.

77. A printed article comprising the lithographic radiation curable hybrid ink or coating composition of claim 50 and a substrate.

78. The printed article of claim 77, which forms part of a packaging article.

79. A method of making the lithographic radiation curable hybrid ink or coating composition of claim 50, comprising the steps of:
a) providing:
(i) one or more inert hard resins selected from the group consisting of rosin resins, rosin resin derivatives, hydrocarbon resins, modified hydrocarbon resins, iso diallyl phthalate resins, non-phthalate allyl resins, and combinations thereof;
(ii) non-UV raw material selected from the group consisting of inert hard resins, vegetable oils, vegetable oil esters, alkyds resins, antioxidants, and combinations thereof; and
(iii) one or more multifunctional (meth)acrylate monomers and/or oligomers; and
b) mixing the components together to make the hybrid ink or coating.

80. A method of printing the lithographic radiation curable hybrid ink or coating composition of claim 50, comprising the steps of:
a) providing the lithographic radiation curable hybrid ink or coating;
b) printing the lithographic ink or coating onto a substrate; and
c) curing the lithographic radiation curable hybrid ink or coating.

81. The method of claim 80, wherein the curing is performed using UV-irradiation.

82. The method of claim 80, wherein the curing is performed using electron beam radiation.
